(19) United States
(12) Patent Application Publication
(10) Pub. No.: US 2013/0295536 A1
(43) Pub. Date: Nov. 7, 2013

(54) APPARATUS AND METHOD FOR TOOLS FOR MATHEMATICS INSTRUCTION

(71) Applicant: CONCEPTUA MATH, (US)

(72) Inventors: Arjan KHALSA, San Rafael, CA (US); Edward MURPHY, Novato, CA (US)

(73) Assignee: CONCEPTUA MATH, Petaluma, CA (US)

(21) Appl. No.: 13/860,389

(22) Filed: Apr. 10, 2013

Related U.S. Application Data
(60) Provisional application No. 61/622,943, filed on Apr. 11, 2012.

(51) Int. Cl. G09B 19/02

(52) U.S. Cl. CPC G09B 19/025
USPC 434/188

(57) ABSTRACT

An apparatus and method for computer-implemented tools for mathematics instruction are provided. These tools enable providing a context for a given problem, e.g. a mathematical problem. Such tools enable demonstrating understanding of the problem by enabling paraphrasing the context. The tools enable further understanding of the problem by enabling using models to depict the paraphrase. The tools further enable solving the problem. For example, a tool enables students to learn what it means to multiply fractions, to represent multiplication of fractions using visual models, and to use equations to compute answers. For example, students may be given a story problem as context. They paraphrase this context, choosing between two types of multiplication problems: groups of and part of. Students use one of two models to depict the paraphrase: the Two Number Line Model or the Double Area Model. Students solve the equation.

### CROSS REFERENCE TO RELATED APPLICATIONS

This patent application claims priority from U.S. provisional patent application Ser. No. 61/622,943, MULTIPLYING FRACTIONS, filed Apr. 11, 2012, the entirety of which is incorporated herein by this reference thereto.

### BACKGROUND OF THE INVENTION

1. Technical Field

This invention relates generally to the field of computer-implemented educational tools in mathematics. More specifically, this invention relates to computer-implemented educational tools for facilitating the teaching of mathematics by employing interactive techniques that support the teacher-student collaboration desired for a student mastering an area of mathematics.

2. Description of the Related Art

Mathematics may be difficult to each and may be difficult for students to learn. Fractions, for example, have been found to be both difficult to teach and difficult for students to learn. At the same time, fractions, as well as other areas of mathematics, are a pivotal topic in mathematics education. Strategic use of technology can help support the teacher-student collaboration required to master this wide-ranging subject area.

An example: The challenges with fractions.

“Learning about fractions in the upper elementary grades is hard. Really hard! Fractions are hard not only for children to learn but for teachers to teach.” This is how Marilyn Burns, the highly esteemed author on elementary mathematics education, begins her first of three extensive books on teaching fractions (Burns, 2001). The National Math Advisory Panel identified fractions as an area that requires special attention: “Difficulty with fractions (including decimals and percent) is pervasive and is a major obstacle to further progress in mathematics, including algebra” (National Math Advisory Panel, 2008, p. xix). This challenge is understandable. Fractions present major conceptual leaps for students.

Consider these factors:
Fractions can describe many different things. When Sarah drinks half of the water in the bottle, she is consuming part of a whole (½). When Jeremy eats three of nine carrot sticks, he is consuming part of a set ( 3/9 or ⅓). When Justin reads for 15 minutes, that represents ¼ of a common unit of time. When Hannah swims across the lake her feat is a measure of length (e.g., 1⅓ miles). And on it goes, from one quarter of a dollar, to ⅓ cup of flour, to ½ of an acre of land. Fractions represent so many different things!
Sophisticated reasoning is required to evaluate any fraction. Upon entering the topic of fractions, students must analyze the relationship between two numbers in order to understand a single value. For example, ⅛ is smaller than ¼, and ⅜ is larger than ¼.
The real value of fractions is dependent upon the unit, or whole, of which they are a part. ¾ is not always greater than ¼! ¾ of a county is a smaller region than ¼ of a continent.
Fractions present a plethora of new terms for students to master: numerator, denominator, equivalent, common, uncommon, proper, improper, and more.
Students must first learn what fractions mean, and then they must perform operations on these fractions. Some of these operations, like addition and subtraction with uncommon denominators, require multiple steps. Other operations, like multiplying and dividing fractions, seem very abstract to many people, and disconnected from anything in real life. (Can you find a real life example of ⅛÷⅓? It is possible, but certainly not trivial!)

It would be advantageous to provide computer-implemented educational tools that address and target the particular challenges for both the student and teacher about the teaching of and the learning of particular areas of mathematics, e.g. fractions, as described hereinabove.

### SUMMARY OF THE INVENTION

An apparatus and method for computer-implemented tools for mathematics instruction are provided. These tools enable providing a context for a given problem, e.g. a mathematical problem. Such tools enable demonstrating understanding of the problem by enabling paraphrasing the context. The tools enable further understanding of the problem by enabling using models to depict the paraphrase. The tools further enable solving the problem. For example, a tool enables students to learn what it means to multiply fractions, to represent multiplication of fractions using visual models, and to use equations to compute answers. For example, students may be given a story problem as context. They paraphrase this context, choosing between two types of multiplication problems: groups of and part of. Students use one of two models to depict the paraphrase: the Two Number Line Model or the Double Area Model. Students solve the equation.

### BRIEF DESCRIPTION OF THE DRAWINGS

FIG. 1 shows a sample screen shot of the online multiplying fractions tool in which a context area, a paraphrase area, a model area, and an equation area are shown, according to the invention;

FIG. 2 shows a screen shot of all four layers, each layer populated with consistent data, according to the invention;

FIG. 3 shows only the context and paraphrase are displayed in an example screen shot where the student is learning to paraphrase, according to the invention;

FIG. 4 shows a screenshot of a context first typed into the context field on the tool, it appears as regular text, according to the invention;

FIG. 5 shows a screen shot of the context and the paraphrase, according to the invention;

FIGS. 6-8 show a screen shot of the result of the student dragging content from the context of FIG. 5 into respective fields in the paraphrase, according to the invention;

FIG. 9 shows an example screen shot of a “groups of” paraphrase, according to the invention;

FIG. 10 shows an example screen shot of a “part of” paraphrase, according to the invention;

FIG. 11 shows a screen shot of a particular example of the groups of model, according to the invention;

FIGS. 12-17 show screen shots of successive steps in solving a particular problem using the groups of model, according to the invention;

FIGS. 18-24 show screen shots of successive steps in solving a particular problem using the part of model, according to the invention;

FIGS. 25-35 show screen shots of the operations for a groups of problem, according to the invention;

FIGS. 36-46 show screen shots of the operations for a part of problem, according to the invention;

FIG. 47 shows a screen shot of the paraphrase stating the problem: 6 groups of ⅓, or 6×⅓, according to the invention;

FIGS. 48-52 show screen shots depicting the sequence of solving a particular groups of problem, according to the invention;

FIG. 53 shows an example screen shot of a part of problem using the two areas model, according to the invention;

FIGS. 54-58 show screen shots for an example sequence of using the two areas model for a part of problem, according to the invention;

FIGS. 59-72 show screen shots for an example sequence of operations using the two areas model for a groups of problem, according to the invention;

FIGS. 73-82 show screen shots for an example sequence of operations using the two areas model for a part of problem, according to the invention;

FIG. 83 shows a screen shot of the four portions of the equation layer, according to the invention;

FIG. 84 shows the functions of the buttons on the left side of the tool, according to the invention;

FIG. 85 shows the functions of the buttons on the upper right side of the tool, according to the invention;

FIG. 86 shows the functions of the buttons on the bottom of the tool, according to the invention;

FIGS. 87-91 show examples of hiding and showing layers, according to the invention;

FIGS. 92-96 show examples of pre-populating and locking content within layers, according to the invention; and

FIG. 97 is a block schematic diagram of a system in the exemplary form of a computer system, according to an embodiment; and

FIG. 98 are example interfaces showing different representations of two different problems, according to the invention.

### DETAILED DESCRIPTION OF THE INVENTION

### Overview

An apparatus and method for computer-implemented tools for mathematics instruction are provided. These tools enable providing a context for a given problem, e.g. a mathematical problem. Such tools enable demonstrating understanding of the problem by enabling paraphrasing the context. The tools enable further understanding of the problem by enabling using models to depict the paraphrase. The tools further enable solving the problem.

For example, a tool enables students to learn what it means to multiply fractions, to represent multiplication of fractions using visual models, and to use equations to compute answers. For example, students may be given a story problem as context. They paraphrase this context, choosing between two types of multiplication problems: groups of and part of. Students use one of two models to depict the paraphrase: the Two Number Line Model or the Double Area Model. Students solve the equation.

It should be appreciated that persons of ordinary skill in the art will understand that apparatus and methods in accordance with this invention may be practiced without such specific details. For example, some details hereinbelow are about the operations of multiplying fractions. However, tools for division of fractions can be constructed and used using core functionality and structure as described hereinbelow. As another example, the tools may not be limited by solving mathematical problems. Using core functionality and structure described herein, tools may be constructed and used for solving physics problems, engineering problems, problems in chemistry, and so on.

### An Embodiment—Multiplying Fractions

An embodiment for enabling tools for mathematical instruction can be understood using the concept of multiplying fractions. An embodiment allows creating a series of lessons, with which students learn what it means to multiply fractions, how to represent the multiplication of fractions using visual models, and how to use equations to compute the answer, as mentioned hereinabove. In accordance with an embodiment, a multiplying fractions tool is provided that is a visual learning tool and that enables the following sequence to unfold:
Students are given a story problem or context.
They learn to paraphrase this context, choosing between two types of multiplication problems: groups of and part of.
Students use one of two models to depict the paraphrase: the Two Number Line Model or the Double Area Model.
Students solve the equation, and the equation is segmented into specific portions for educational scaffolding.

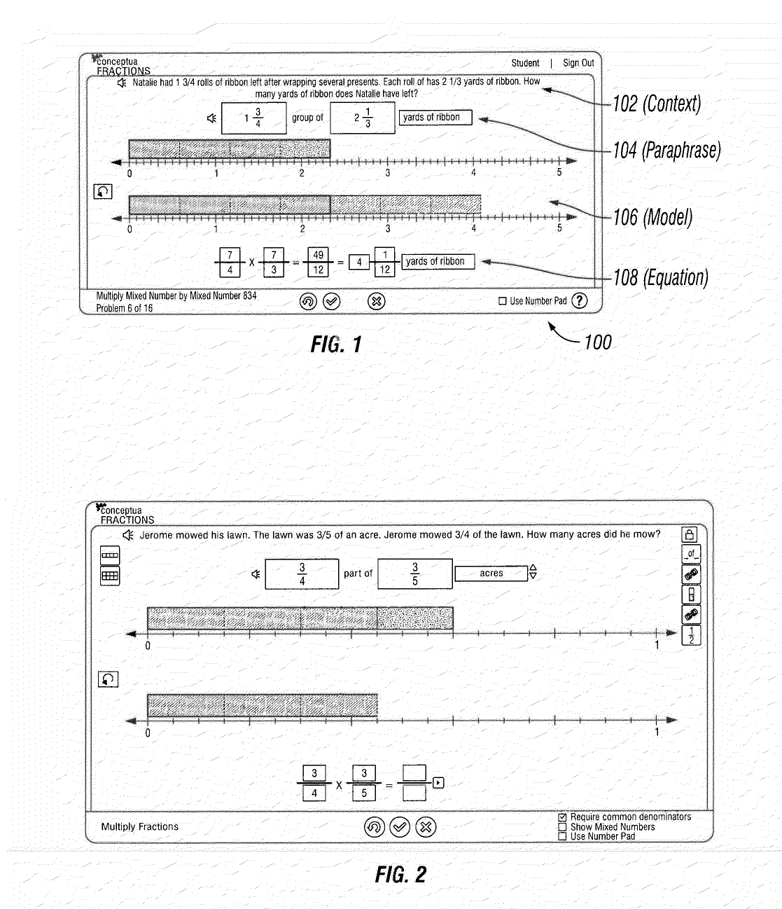

An example can be understood with reference to FIG. 1. FIG. 1 shows a sample screen shot of the online multiplying fractions tool 100 in which a context area 102, a paraphrase area 104, a model area 106, and an equation area 108 are shown. It should be appreciated that the details are for illustrative purposes only and are not meant to be limiting. For example, the equations area could also be an area in which numbers representations are shown. For example, perhaps in an embodiment, no operations are necessary, and only number representations are important. As well, in a physics or engineering tool, the equations area may not have many numbers, but mostly algebraic symbols and mathematical constants.

Layers. As described above, an embodiment comprises four essential parts, or layers:
Context
Paraphrase: groups of and part of
Model: Two Number Line and Double Area
Equation

The combination of the context, paraphrase, model and equation is unique and their linkage is unique. Below are described three features which enable the unique and combinations and linkages.

Hide and Show. At any given time, any or all of the layers may be displayed. When a layer is depicted as hidden, it does not appear at all on the screen. When a layer is depicted as shown, it does, affirmatively, appear on the screen.

Linking. These layers may be linked together, or unlinked, in various combinations. When the paraphrase and models are linked, then the models automatically render as the paraphrase is completed. That is, the models automatically update their data and display to reflect the data in the paraphrase and the paraphrase automatically updates its data and display to reflect the data in the models. When the models and equation are linked, the equation fields are automatically updated to reflect the updated data in the model and the models are automatically updated to reflect the updated data in the equation fields.

An example can be understood with reference to FIG. 2, which shows a screen shot of all four layers, each layer populated with consistent data. That is, the context layer is about ¾ of ⅗ in a word problem, the top model shows ¾ colored in of a ⅗ section. The bottom model shows just the answer. And, the equation area shows the equation, but not the answer. In this embodiment, the student may fill in the answer.

Locking. One or more fields of any layer may be locked. For example, authors who develop lessons may have the ability to lock specific fields within any layer. When a field is locked, the information presented cannot be directly edited by the user, such as for example through typing, cut and paste operations, drag and drop operations or custom widgets, such as increment buttons. However, the field may be changed though values propagated to it either implicitly, as with fields within an equation, or explicitly, as with .fields within sections that are selected as linked.

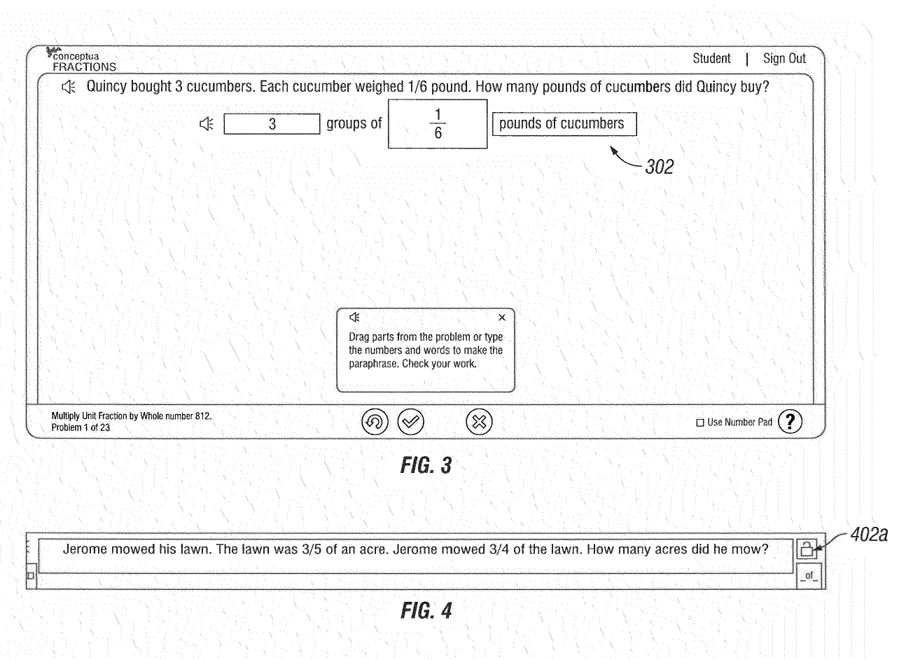

Example Implementation. An embodiment enables a user to create a lesson. For example, an author may create a lesson, sometimes referred to herein as scaffolding instructions, with the multiplying fractions tool by using these methods:
Hide and show specific layers at specific times to target a learning objective. For example, to teach initially the skill of paraphrasing a story problem, the author may create the lesson to show only the context and paraphrase. To teach rendering a model, the author may add the model to the lesson. To teach the relationship between a model and the equation, the author may be certain that both of these layers are displayed. An example of using hidden layers may be understood with reference to FIG. 3, in which only the context and paraphrase are displayed 302 in an example where the student is learning to paraphrase. That is, the model layer and the equation layer are hidden.
Link or unlink specific layers to change the student's required response. For example, to show how the creation of a paraphrase directly relates to a model, the author may link the two and the model is automatically rendered. That is, when the paraphrase layer is populated with particular data, the model layer is automatically updated with corresponding data to be consistent with the paraphrase layer. To have the student create a model on their own or to provide data for a displayed model on their own, the author may choose to unlink the model from the paraphrase.
Lock specific portions of a given layer to guide a student's learning trajectory. For example, to help a student master equations, a portion of a particular equation may be completed by the author and locked by the author. This way, the student may complete a specific portion of the equation and progress towards completing the entire equation.

### Context and Paraphrase

An embodiment enables the ability to parse text within a context into a choice of paraphrases. The paraphrase section is used to paraphrase the context into a shorter sentence or phrase the fields of which can be directly related to a mathematical model and/or equation. Importantly, the paraphrase can be directly related to the underlying mathematics. Such mechanism allows linking the paraphrase fields to the model and/or the equation. Put another way, the paraphrase is a combination of text, numbers or symbols that reduce a mathematical problem, such as presented in the context section, into a single phrase or sentence the parts of which can be directly and predictably expressed as a mathematical model and/or equation.

It should be appreciated that this context-to-paraphrase capability is not limited to the multiplication of fractions. As discussed above, these layers, and context-to-paraphrase, in particular, may be applied to any mathematical or mathematical sciences topic. Following are some aspects of context and paraphrase in accordance with embodiments herein. Further detailed descriptions of these aspects are described further below in this document.
The tool user or activity author may write a context, such as a story problem.
This context may be locked. When the context field is locked, the text of the context field is not editable. The text may be available or activated for use as described below.
The author may specify which words or phrases can be grouped when dragged.
The user selects, e.g. by clicking, a specific word, phrase, or number, and copies it into a paraphrase. For example, the user may click a word and the phrase in which the word belongs automatically highlights. Then, the user may use drag-and-drop operations to drag the highlighted phrase from the context layer to a chosen field in the paraphrase layer or via copy-and-paste operations.
The user may also type directly into a field in the paraphrase layer.
The fields of the paraphrase are intelligent and correlate to both the models and the equation. That is, there is an underlying equation, such as a mathematical equation, the part of which correspond to each of the paraphrase, models, and equation layers. Thus, when one field of the paraphrase layer is populated with particular data, then the corresponding fields or areas of the models layer and equations layers get automatically updated in accordance with embodiments herein.
The accuracy of the paraphrase is checkable. For example, the author may determine which words, phrases, or numbers must be placed into each text field in the paraphrase in order for the answer to be accurate.
The paraphrase may also trigger the check-ability of the use of models and execution of the equation. For example, if a student places text and numbers into a paraphrase, the program checks to determine whether their use of the models and/or their statement of the equation exactly match the paraphrase.

The Context. In an embodiment, a context layer may comprise one or more different types of contexts, each of which may be correlated with one of one or more different types of paraphrases. For example, the multiply fractions tool may comprise two different particular paraphrases as follows. One such paraphrase involves groups of things and the other paraphrase involves part of things. In this tool, such contexts are presented as story problems.

Table A lists examples of the “groups of” context with corresponding paraphrases, in accordance with embodiments herein.

TABLE A

| Groups Of Contexts | The Paraphrase |
|---|---|
| There are 6 granola bars in a box. If Mel | 3 groups of 6 granola |
| bought 3 boxes, how many granola bars did | bars |
| Mel buy? | |
| Regina took her children to swimming classes | 8 groups of ¾ hours |
| for 8 weeks. Each class was ¾ of an hour | |
| long. How many hours did Regina's children | |
| spend in swimming classes? | |
| When Mariah ran on the treadmill she ran for | 4 groups of 2½ miles |
| 2½ miles, but when she ran outside, she ran | |
| 4 times as far. How many miles did Mariah | |
| run when she ran outside? | |
| If Kevin can type 3½ pages in an hour and he | 1¾ groups of 3½ pages |
| spent 1¾ hours typing his report, how many | |
| pages long was his report? | |

TABLE B
Table B lists examples of the “part of” context with corresponding
paraphrases, in accordance with embodiments herein.

| Parts Of Contexts | The Paraphrase |
|---|---|
| The animal shelter had 16 dogs. If ¼ of the | ¼ part of 16 dogs |
| dogs were brown, how many dogs at the | |
| animal shelter were brown? | |
| The town soccer fields occupy 6 acres of land. | ⅞ part of 6 acres |
| The baseball fields occupy ⅞ as much land. | |
| How many acres do the baseball fields occupy? | |
| New houses were being built in a | ⅔ part of ⅘ houses |
| neighborhood. If ⅘ of the houses were two- | |
| story houses and ⅔ of the two-story houses | |
| were blue, what portion of the houses in the | |
| neighborhood were blue two-story houses? | |

In an embodiment, a groups of paraphrase depicts a groups of problem when the multiplier is greater than or equal to one and a parts of paraphrase depicts a parts of problem when the multiplier is less than one.

In an embodiment, other types of contexts may be provided, as well. For different operations in mathematics, there may be different types of contexts. For each type of context, there may be different types of paraphrases. In other words, it should be appreciated that aspects of the invention address all types of contexts and paraphrases. Some examples include but are not limited to what is shown in Table C:

TABLE C

| Type of Context | Type of Paraphrase |
|---|---|
| Join, result unknown | Addition (2 + 3 = ?) |
| Join, result known | Subtraction or addition (2 + ? = 5, |
| | 5 − 2 = ?) |
| Part, part, whole, whole | Addition (2 + 3 = ?) |
| unknown | |
| Compare, result unknown | Subtraction (7 − 4 = ?) |
| Compare, result known | Subtraction (7 − ? = 3, ? − 4 = 3) |
| Separate, result known | Subtraction (9 − ? = 7) |
| Separate, result unknown | Subtraction (9 − 2 = ?) |

By way of embodiments herein, the user such as the student learns to analyze each context and use the paraphrasing functionality to restate the context.

The Paraphrase. The paraphrase is designed to help a user such as a student understand a story problem, or context, by organizing important elements into a heuristic. An embodiment provides one or more of such important elements that are part of the paraphrase. For example, the paraphrase for multiplying fractions has three editable fields. An embodiment provides a check-work feature for the paraphrase, wherein the embodiment may include alternatives to input into the editable fields. For example, such check-work feature may handle plurality, alternate spellings of words, and alternate phrases. For purposes of understanding the paraphrase in accordance with embodiments herein, the following context is considered:

Jerome mowed his lawn. The lawn was ⅗ of an acre. Jerome mowed ¾ of the lawn. How many acres did he mow?

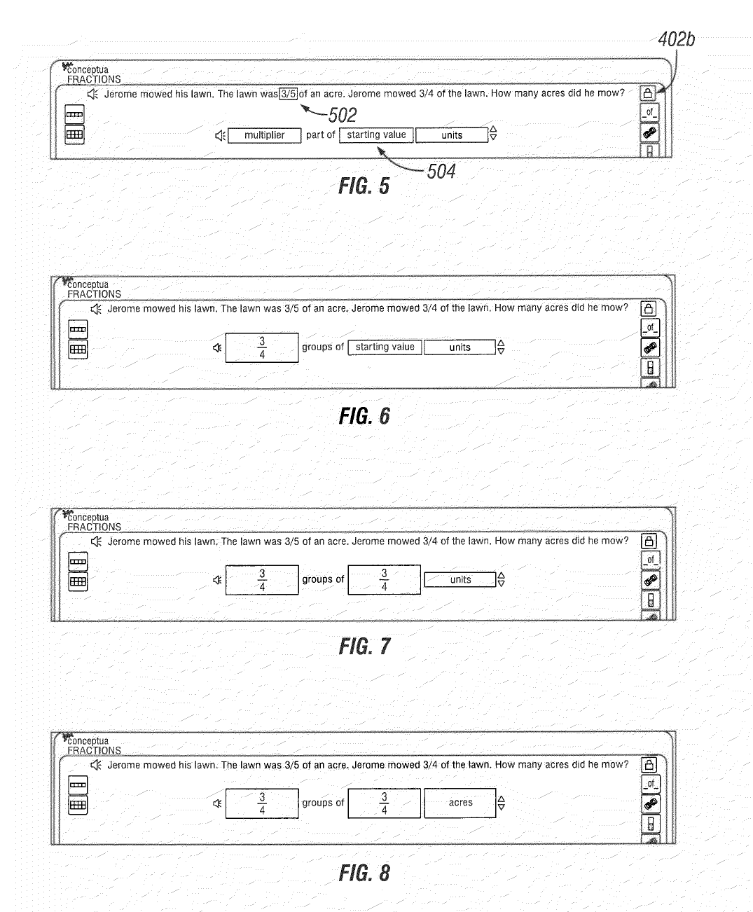

When a context is first typed into the context field on the tool, it appears as regular text, as shown in FIG. 4. Upon clicking the lock button 402a, which is in an unlocked state, the text becomes actionable or locked 402b, as shown in FIG. 5. For example, users may now select part of the text in context field 502. The lock button takes on a new state and the text is no longer editable. As well, the text becomes drag-able.

Referring to FIG. 5, the student has analyzed the context and selects specific numbers or words to place into the editable fields 504 of the paraphrase. The student may also type directly into the paraphrase.

Continuing with the example starting in the previous two figures, FIG. 6, FIG. 7, and FIG. 8 depict the subsequent actions of dragging elements of the context into a paraphrase. FIG. 6 shows the result when the student drags the multiplier into the multiplier field of the paraphrase. FIG. 7 shows the result when the student drags the starting value into the starting value field of the paraphrase. FIG. 8 shows the result when the student drags the name for the units into the units field of the paraphrase.

It should be appreciated that the order in which the user such as the student completes the paraphrase is flexible. For example, the student may drag the starting value into the starting value field of the paraphrase before dragging the multiplier into the multiplier field of the paraphrase. It should further be appreciated that for purposes of understanding herein, the term, starting value, is used for the term, multiplicand. Starting value and multiplicand have the same meaning herein.

Table D provides a list of the editable fields in the paraphrase and their corresponding meaning for purposes of understanding herein as well as an mapping of the editable field with actual data in the above-described example.

TABLE D
Editable Fields in the Paraphrase

The starting value, or multiplicand
The multiplier
The unit

These fields in the paraphrase are different when the paraphrase is applied to different mathematical or scientific topics. In the application of the tool to multiplication, the use of the term “starting value” in this document may indicate two things: the initial value in a context upon which a multiplier has an effect and the “multiplicand.”

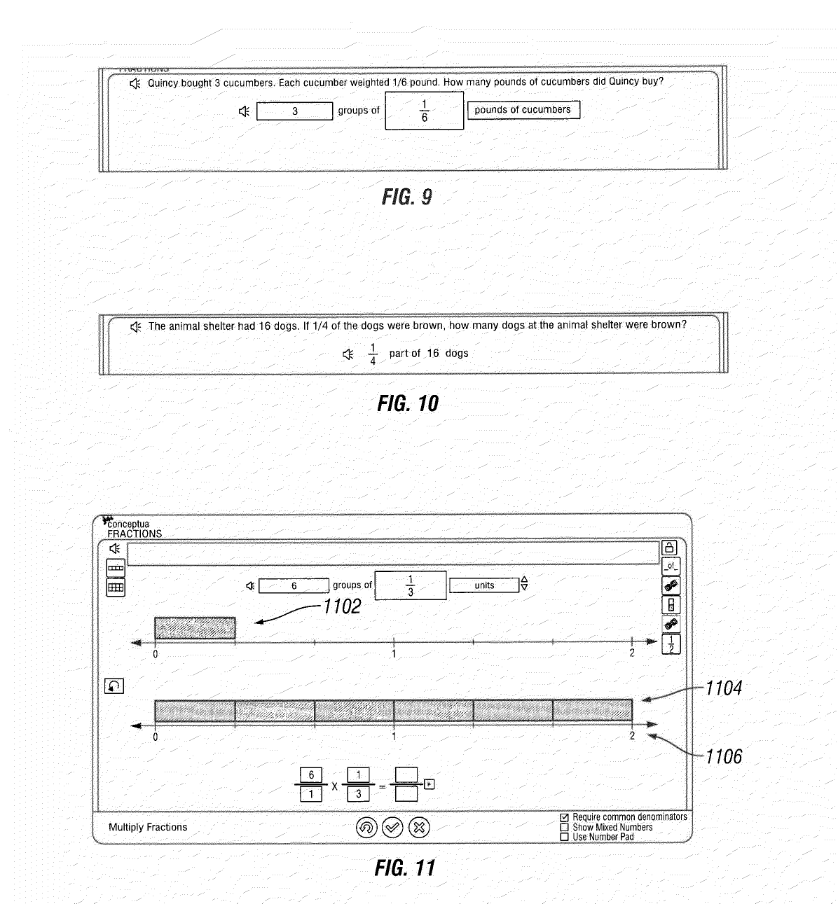

In the specific implementation for the multiplication of fractions, two types of paraphrases are provided, one for each type of context, as follows: The Groups Of Paraphrase and The Part of Paraphrase. FIG. 9 shows an example screen shot of a “groups of” paraphrase. FIG. 10 shows an example screen shot of a “part of” paraphrase.

In other applications of the paraphrase, when employed with other mathematical topics, the system may offer different types of paraphrases.

### Models

In an embodiment, a model layer is provided which may enhance the understanding of the mathematical concept of the user. One or more actual models may be used in any implemented model layer.

For example, in the multiplying fractions tool, two number line models are provided and are described below. The two number line model uses two parallel number lines to depict the starting value, the effect of the multiplier, and the product.

Two Number Line Model—Groups Of. The groups of model may be understood with reference to FIG. 11, a screen shot showing a particular example. In the example, the paraphrase states the problem: 6 groups of ⅓, or 6×⅓. The starting value number line is used to display the starting value of ⅓ (1102.) The product number line is used to organize 6 groups of the starting value 1104. In this case, the value of ⅓ is regarded as a group, and 6 of those groups are placed in the product number line. After the 6 groups are all organized on the product number line, it becomes visually apparent that the product is 2 (1106.)

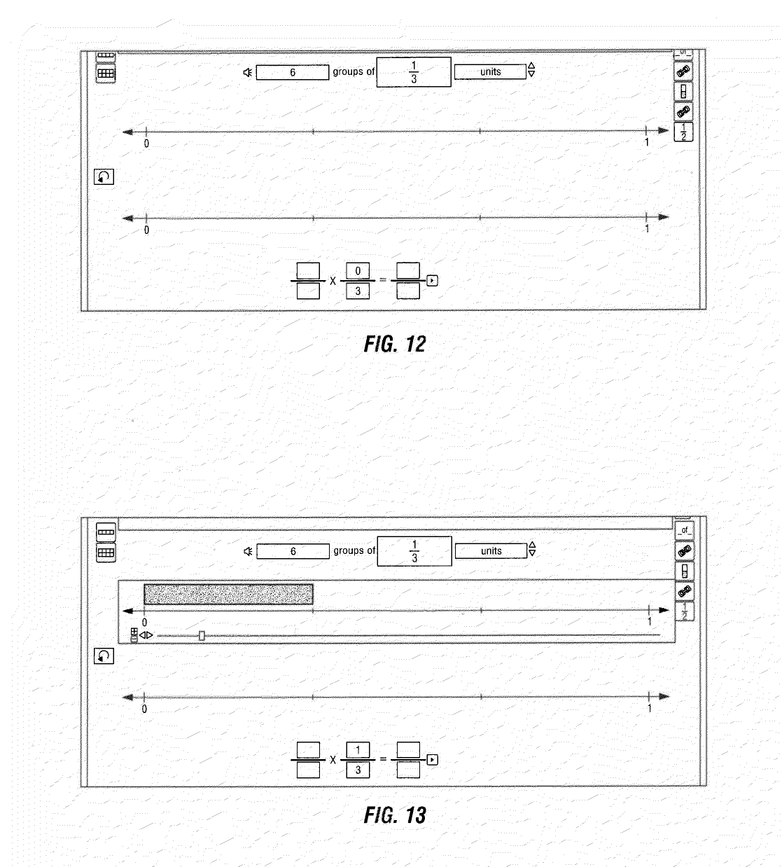

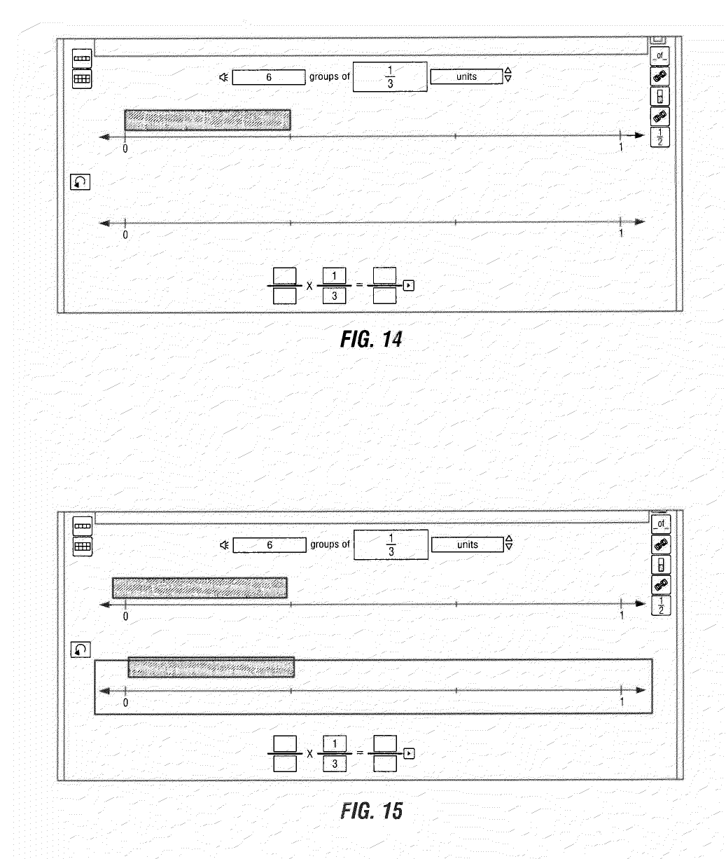

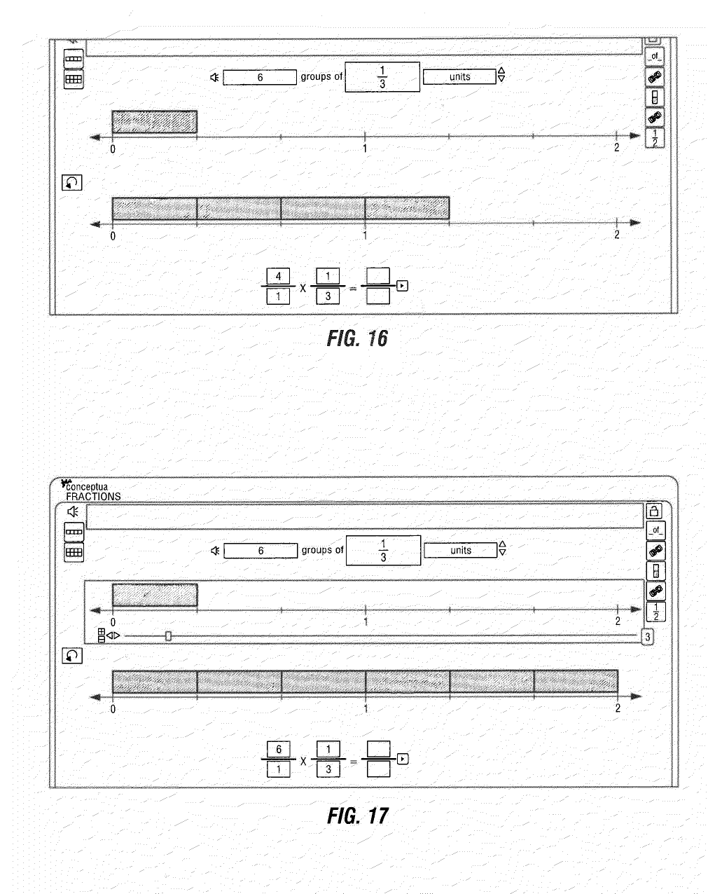

In an embodiment, the model layer may be used flexibly. For example, the user may practice dragging different field values from the paraphrase to the model. An example may be understood with reference to FIGS. 12-17. FIGS. 12-17 show one way to use the model for illustrative purposes only and are not meant to be limiting. When the two number line model is neither linked nor locked, the student must complete the model on their own, step by step. Following is the sequence for this particular example. The student divides the starting value number line into thirds, as shown in FIG. 12. The student creates the model for ⅓, as shown in FIG. 13. The student select the ⅓ piece, as shown in FIG. 14. The student drags a ⅓ piece to the product number line and repeat until all groups are shown, as depicted in FIG. 15. Upon dragging the 4th piece, the number lines automatically recalibrate to accommodate a value greater than 1, as shown in FIG. 16. When all 6 pieces are in place on the product number line, the model is complete, as shown in FIG. 17.

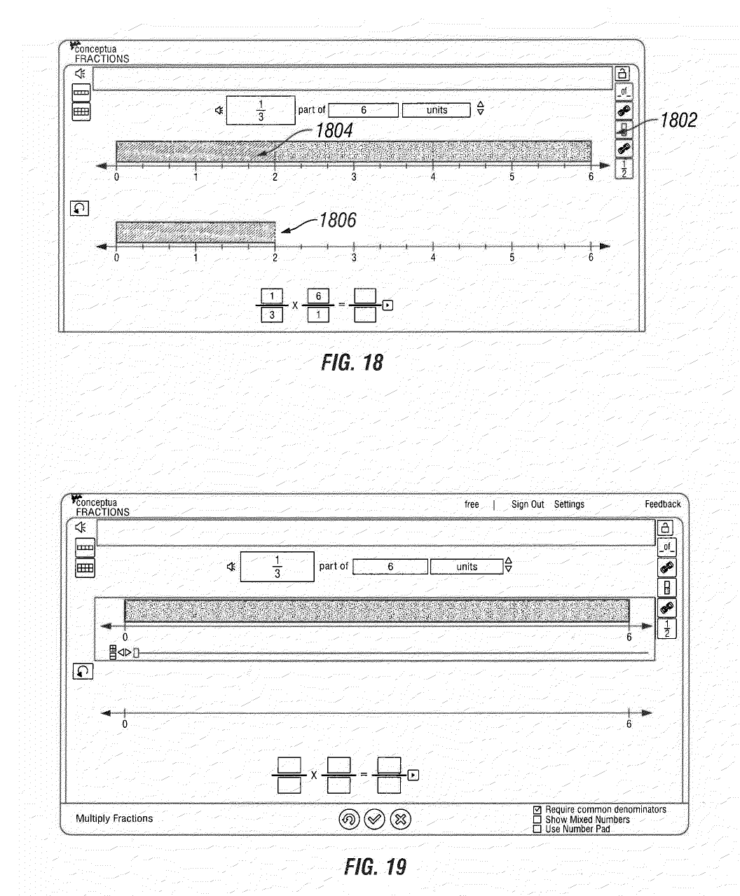

Two Number Lines—Parts Of. When the two number lines model is used to depict a Part Of problem, it is used in a different manner than in the manner of depicting the groups of problem. An embodiment can be understood with reference to FIG. 18, which shows an example of ⅓×6. The answer is identical to the problem above (6×⅓), because multiplication is a commutative operation. However, the reasons for this equivalence are not necessarily apparent to a student or teacher. FIG. 18 shows a starting value (6) in the starting value number line 1802. The multiplier is ⅓ (1804.) The product (2) is shown in the product number line 1806. The model is designed to show the reasoning behind the answer for ⅓×6.

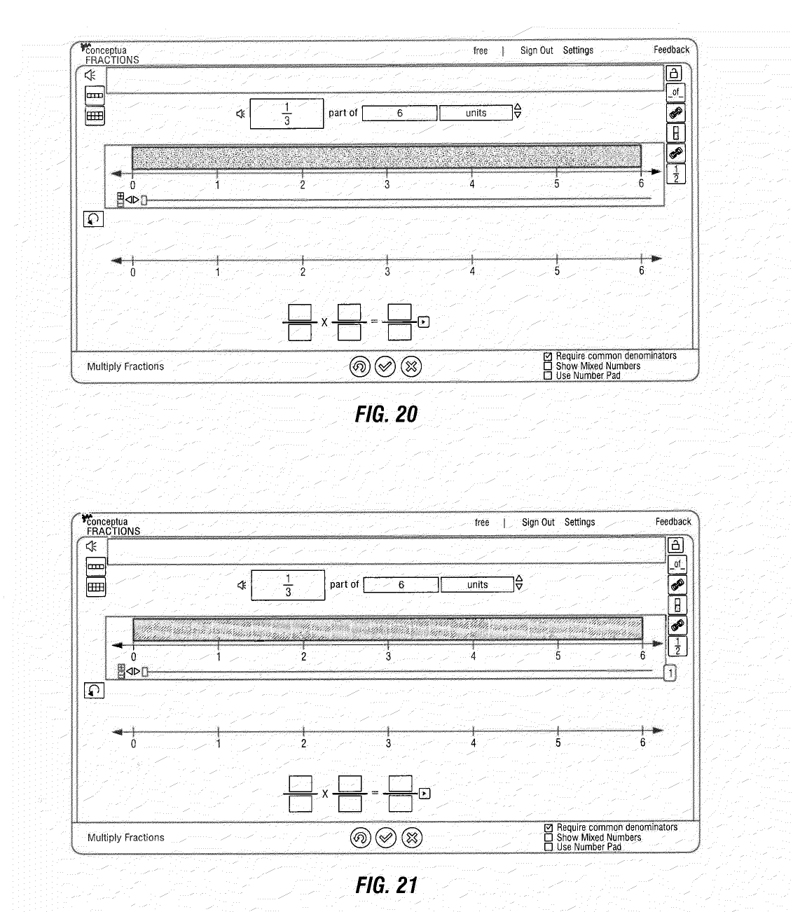

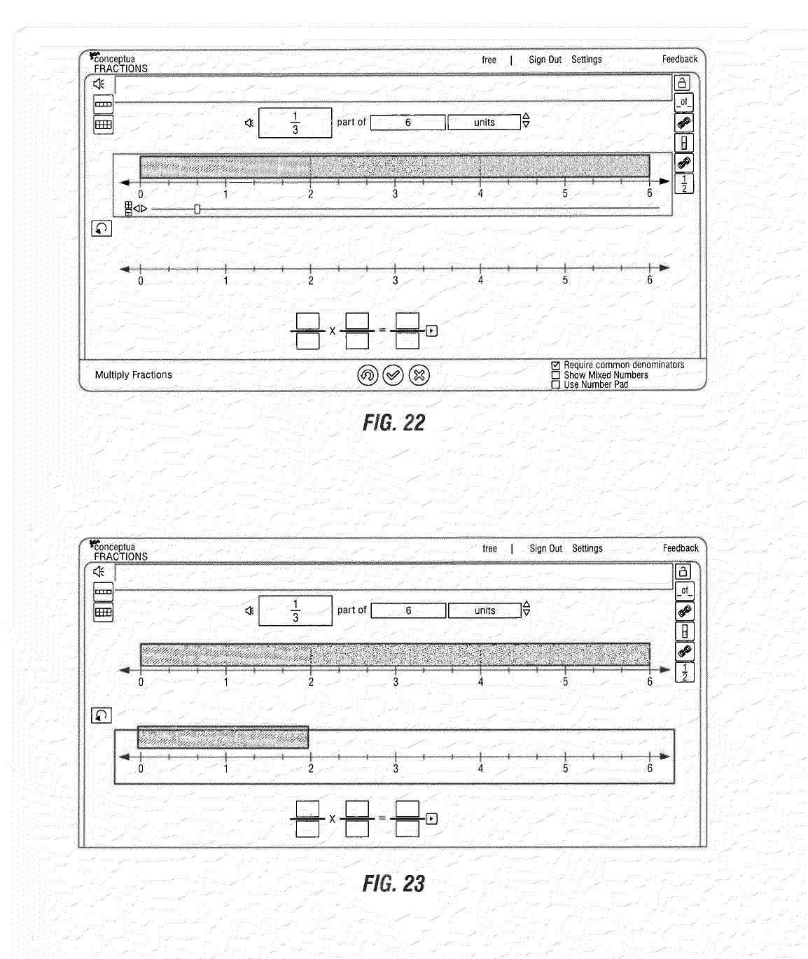

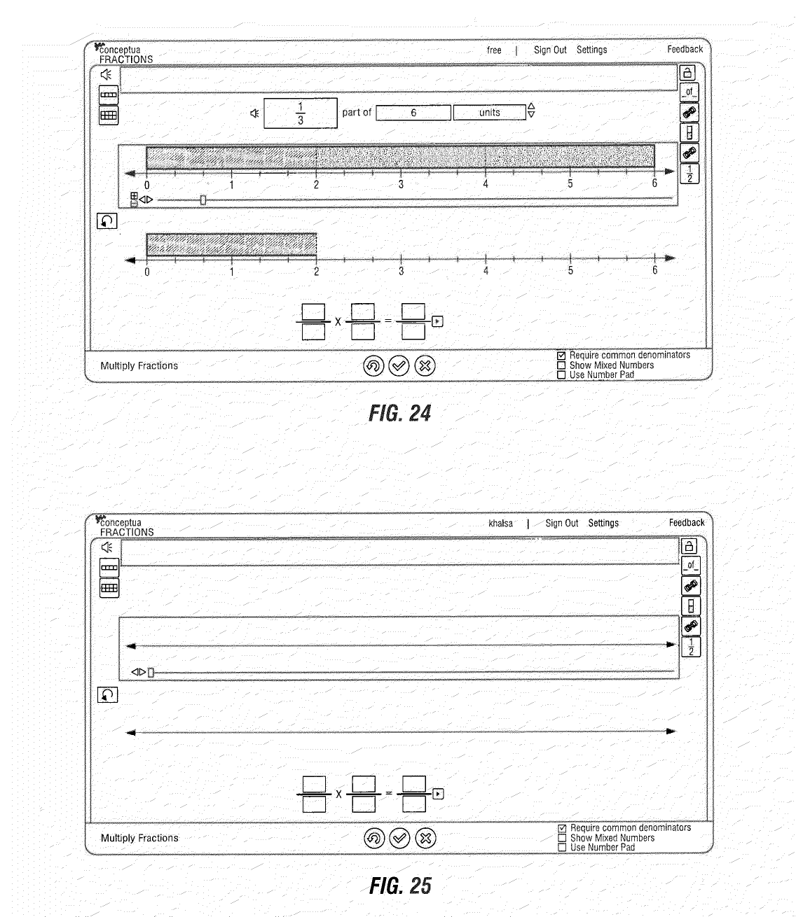

When the two number line model is neither linked nor locked, the student must complete the model on their own, step by step. Following is an example sequence, which may be understood with reference to FIGS. 19-24. The student makes a model for 1, whole, in the starting value line, as shown in FIG. 19. The student repeats the creation of wholes in the starting value line until they have made a total of 6 and the two number lines recalibrate to display a range of 0-6, as shown in FIG. 20. The student selects the model for 6, as shown in FIG. 21. The student divides the 6 into 3 equal parts, and selects one of those equal parts, as shown in FIG. 22. The student drags the one part to the product number line, as shown in FIG. 23. It is now visually clear that ⅓×6=2, as shown in FIG. 24.

Operating the Two Number Lines Model. In an embodiment, the operation of the two number lines model uses particular individual controllers to employ the model.

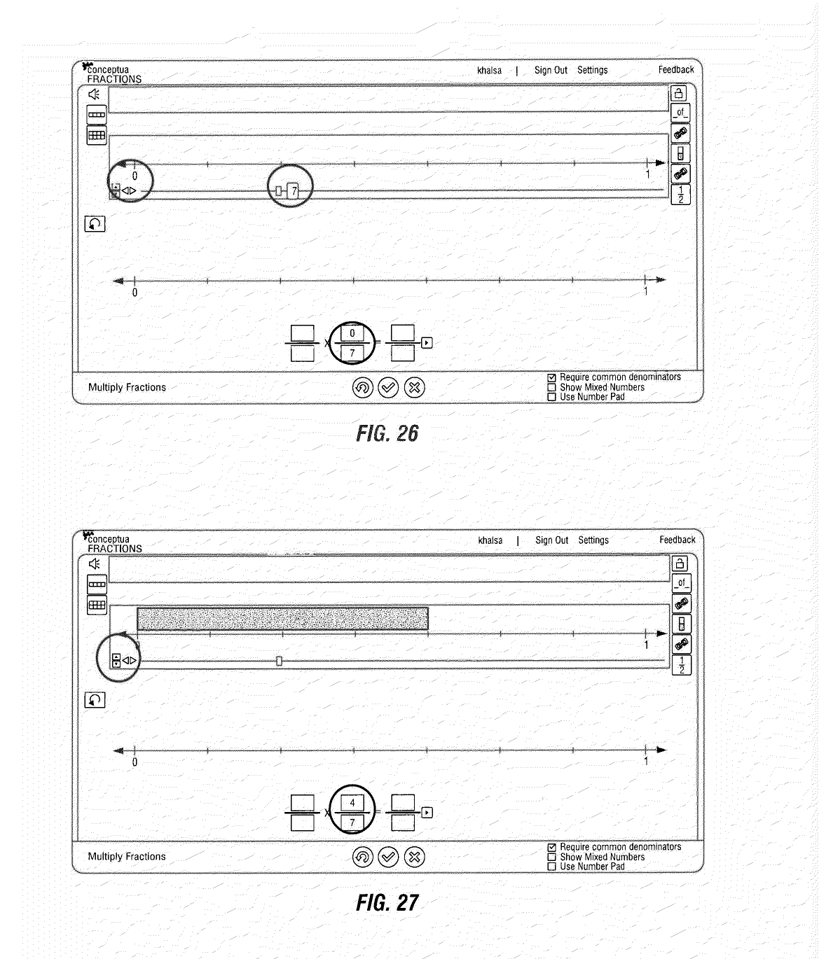

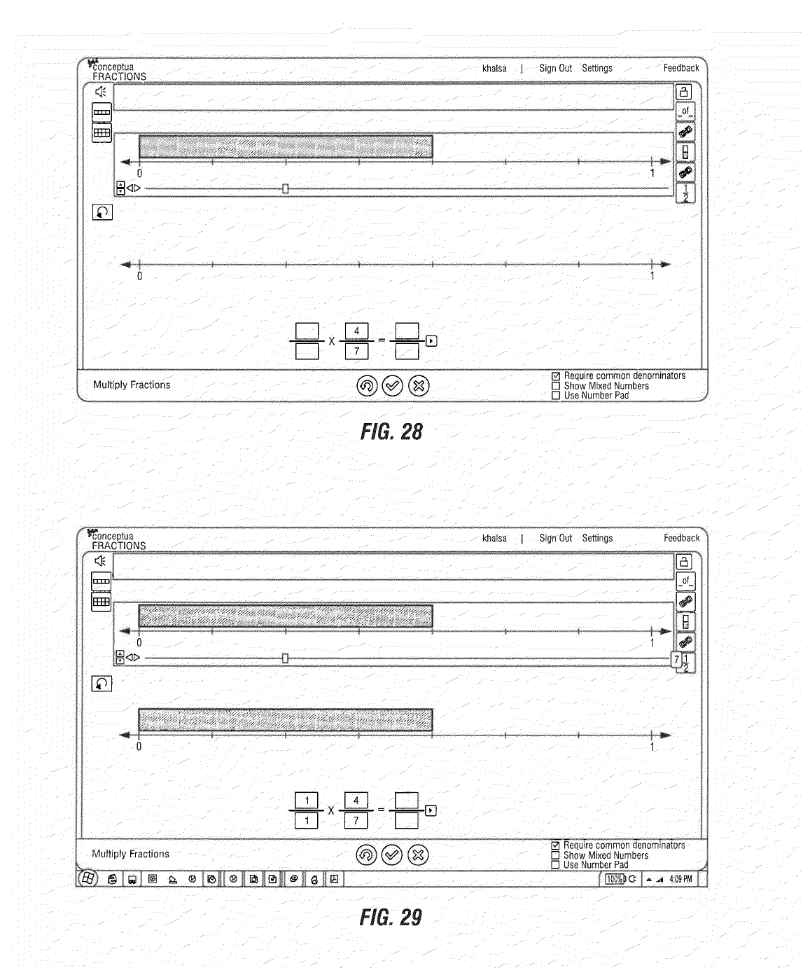

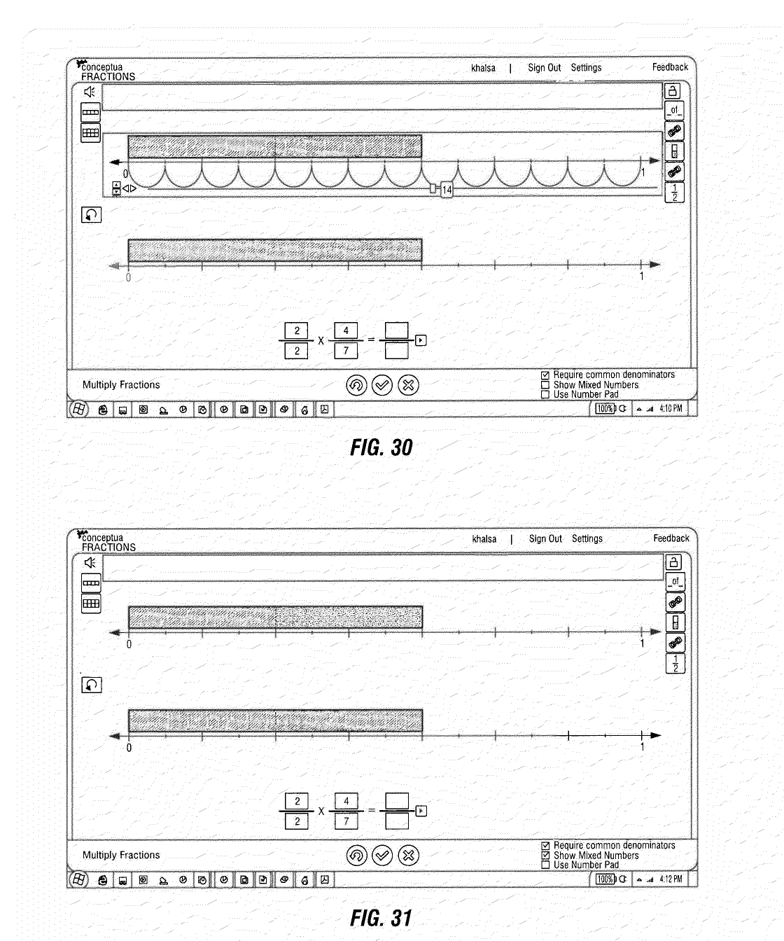

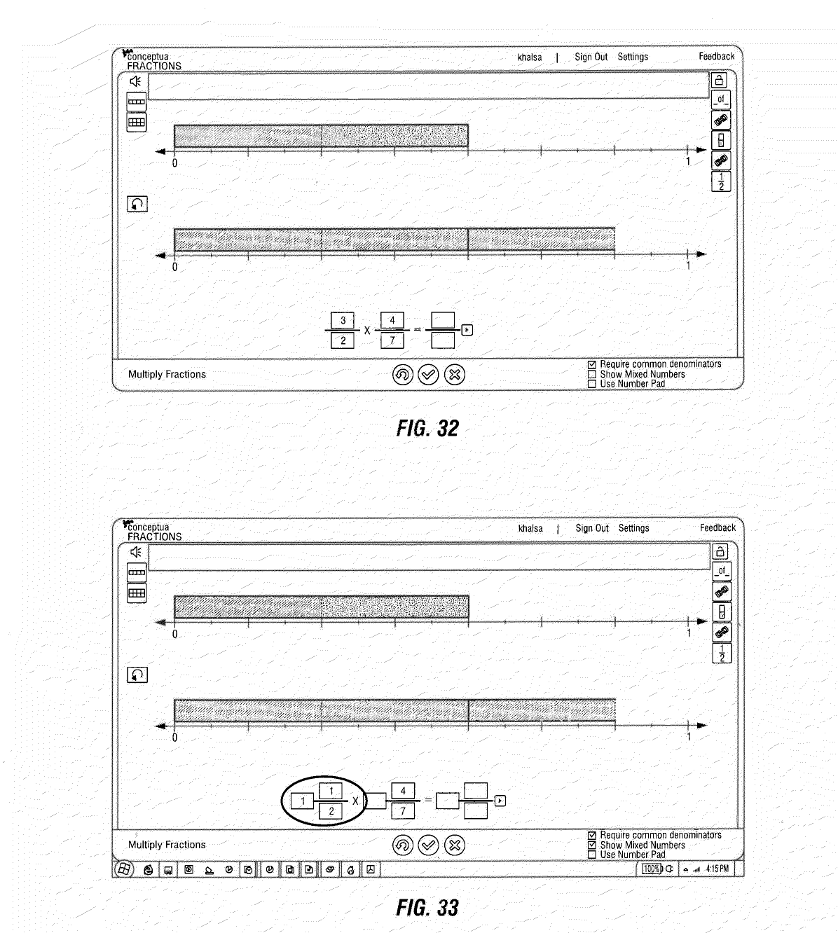

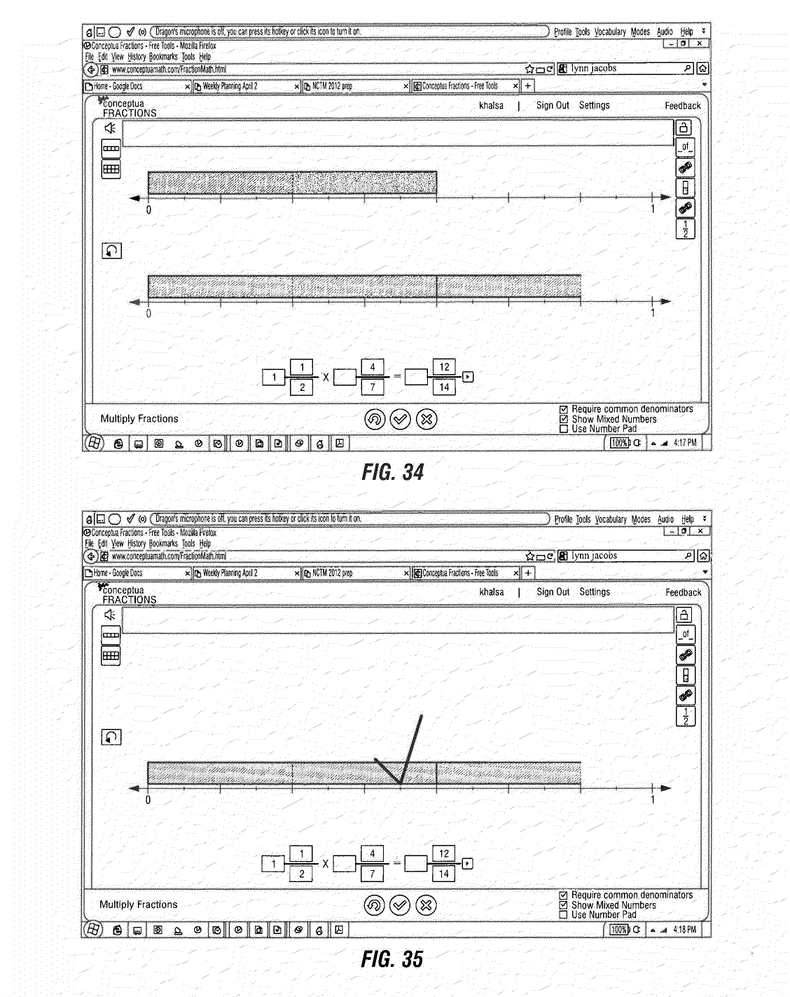

An embodiment of the operations for a groups of problem can be understood with reference to FIGS. 25-35. It should be appreciated that the particular details are meant by way of example only and are not meant to be limiting. To begin with, the controls do not appear (not shown.) The controls appear when the user places the cursor over the model, as shown in FIG. 25. The user clicks on a controller to segment the starting value number line into seven equal parts. Given that linking is turned on, the equation populates the starting value with a denominator of 7, as shown in FIG. 26. The user clicks on a controller to shade four of the seven equal parts. The starting value shaded model now represents 4/7. Given that linking is turned on, the equation populates the starting value with a numerator of 4. The starting value is now represented as 4/7, as shown in FIG. 27. The user clicks on a shaded model in the starting value number line to select it, as shown in FIG. 28. The user drags the model, representing 4/7, to the product number line. The user has now represented 1× 4/7. The user now needs to add another ½× 4/7 to the product number line in order to represent the product, as shown in FIG. 29. The user clicks on a controller to segment the starting value shaded model into 2 equal parts, or halves. This is because the multiplier is 1½. In order to select ½ more of the starting value shaded model, that model must be segmented into halves. At the same time, the denominator of both the starting value and product number lines segments to match the denominator of the starting value shaded model. The denominator is 14, as shown in FIG. 30. The user clicks on the starting value shaded model in order to select one of the two equal parts. This model now accurately depicts ½ of 4/7, as shown in FIG. 31. The user drags the selected portion of the starting value shaded model down to the product number line. The model on the bottom number line now shows 1½ groups of 4/7. The product number line has already been segmented 14 equal parts. It is visually apparent that this shaded model resting on the product number line occupies 12 of those 14 equal parts. Given that linking is turned on, the equation populates the multiplier with a value of 3/2, as shown in FIG. 32. Show mixed numbers has been enabled. The equation now reads 1½× 4/7, as shown in FIG. 33. The user enters the product of the equation: 12/14. The model has served its purpose. It has demonstrated that 1½× 4/7= 12/14, as shown in FIG. 34. Upon selecting the check work button, two things take place. First, a green mark appears, indicating that the equation is correct and that it matches the model. Second, the starting value number line disappears, leaving the product number line and its associated model in place. The purpose for this is to provide the user with a clear visual indication of the answer, as shown in FIG. 35.

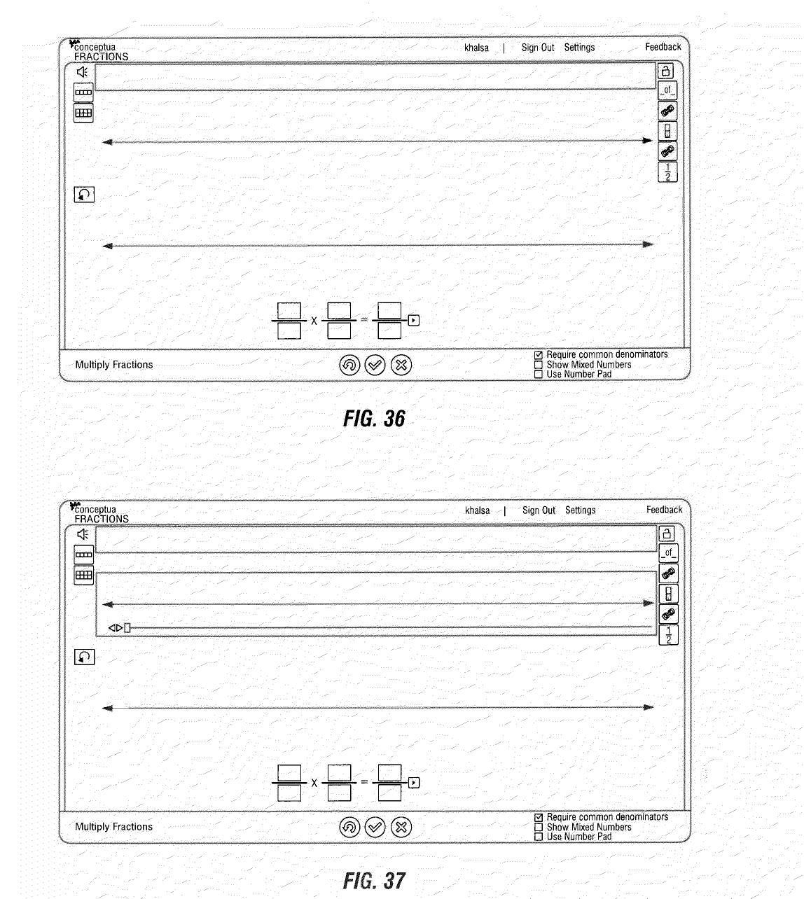

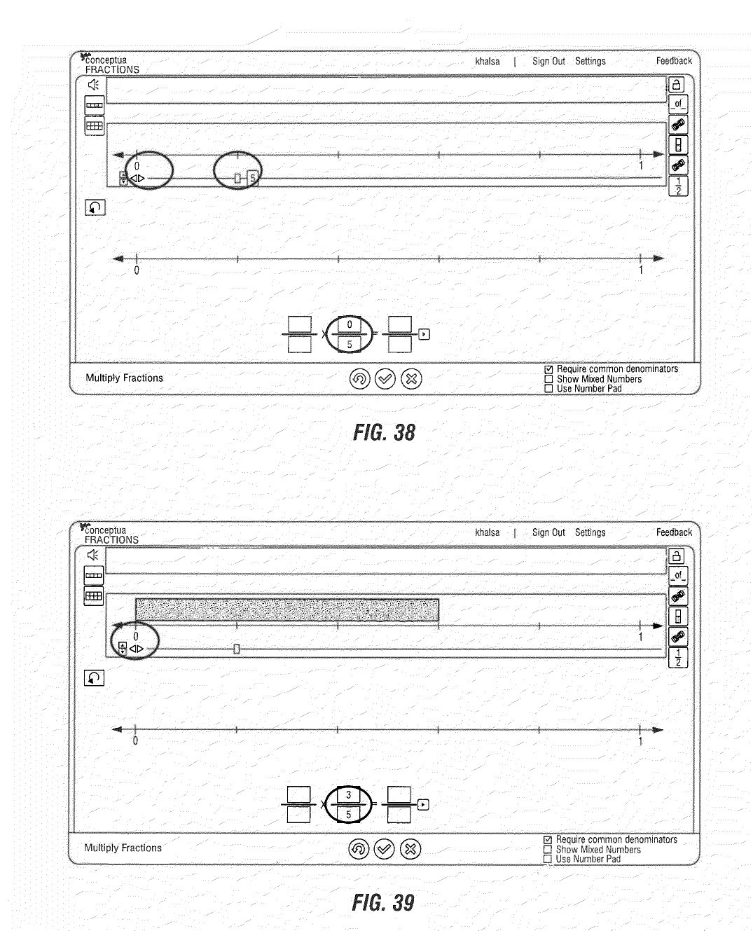

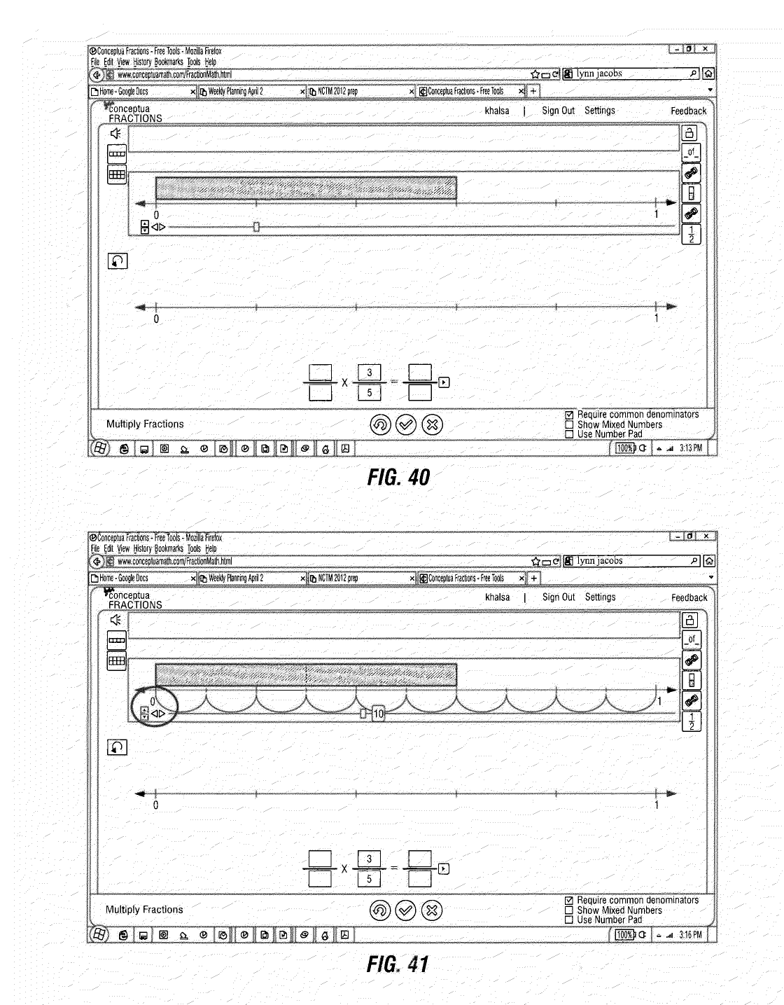

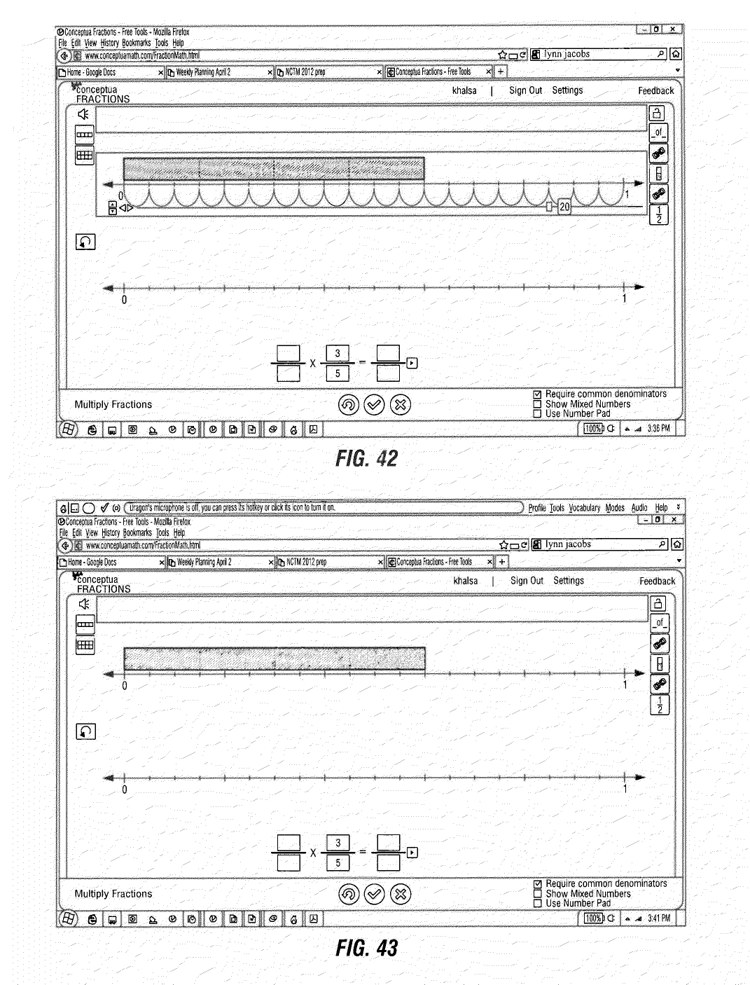

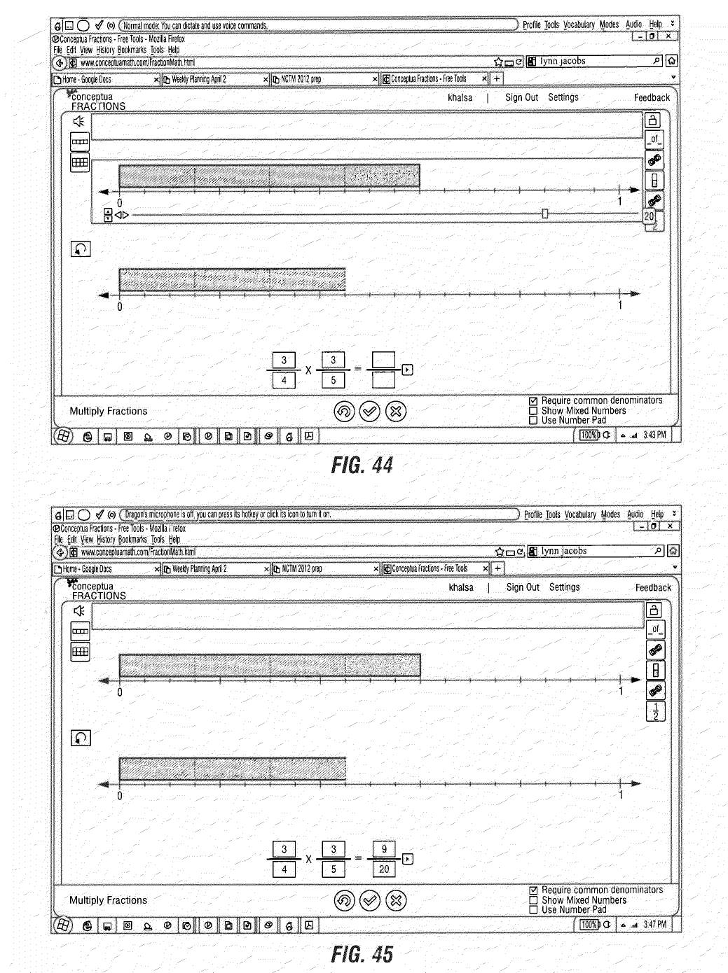

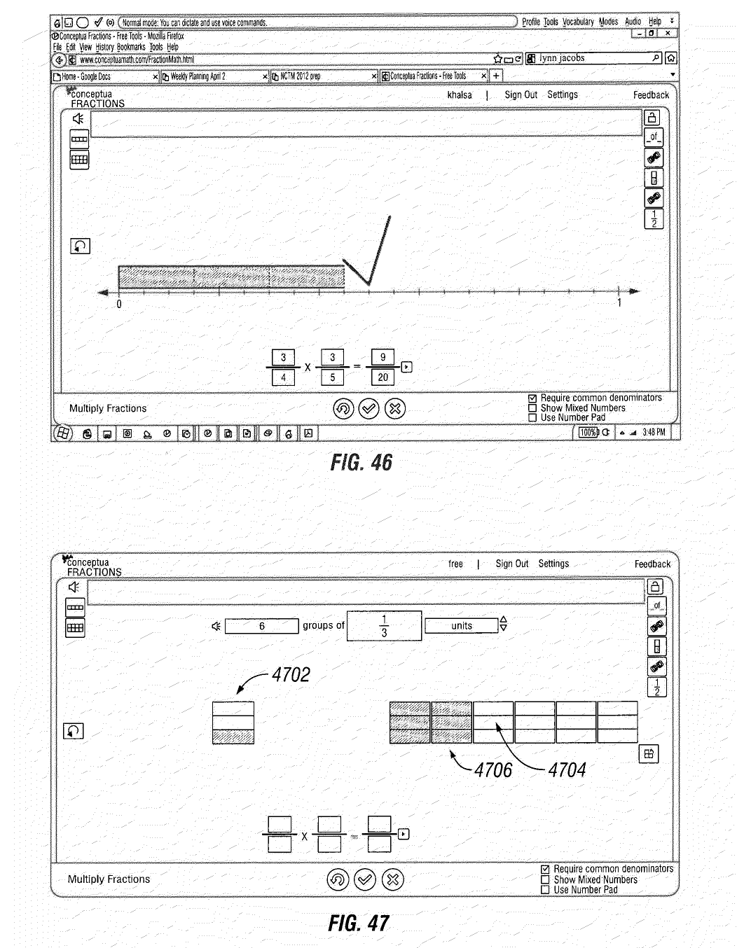

An embodiment of the operations for a part of problem can be understood with reference to FIGS. 36-46. It should be appreciated that the particular details are meant by way of example only and are not meant to be limiting. To begin with, the controls do not appear, as shown in FIG. 36. The controls appear when the user places the cursor over the model, as shown in FIG. 37. The user clicks on a controller to segment the starting value number line into five equal parts. Given that linking is turned on, the equation populates the starting value with a denominator of 5, as shown in FIG. 38. The user clicks on a controller to shade three of the five equal parts. The starting value shaded model now represents ⅗. Given that linking is turned on, the equation populates the starting value with a numerator of 3. The starting value is now represented as ⅗, as shown in FIG. 39. The user clicks on the shaded model in the starting value number line to select it, as shown in FIG. 40. The user clicks on a controller to segment the starting value shaded model into equal parts. At the same time, the denominator of both the starting value and product number lines segments to match the denominator of the starting value shaded model. At the juncture shown to the left, the denominator of both number lines is 10, as shown in FIG. 41. The user clicks on a controller to segment the starting value shaded model into 4 equal parts. This is because the multiplier is ¾. In order to select ¾ of the starting value shaded model, that model must be segmented into fourths. At the same time, the denominator of both the starting value and product number lines segments to match the denominator of the starting value shaded model. The denominator is 20, as shown in FIG. 42. The user clicks on the starting value shaded model in order to select three of the four equal parts. This model now accurately depicts three fourths of ⅗, as shown in FIG. 43. The user drags the selected portion of the starting value shaded model down to the product number line. The product number line has already been segmented 20 equal parts. It is visually apparent that this shaded model resting on the product number line occupies nine of those 20 equal parts. Given that linking is turned on, the equation populates the multiplier with a value of ¾, as shown in FIG. 44. The user enters the product of the equation: 9/20. The model has served its purpose. It has demonstrated that ¾×⅗ equals 9/20, as shown in FIG. 45. Upon selecting the check work button, two things take place. First, a green mark appears, indicating that the equation is correct and that it matches the model. Second, the starting value number line disappears, leaving the product number line and its associated model in place. The purpose for this is to provide the user with a clear visual indication of the answer, as shown in FIG. 46.

In an embodiment, in the multiplying fractions tool, a two areas model is provided and described below. The two areas model uses two adjacent areas models to depict the starting value, the effect of the multiplier, and the product.

Two Areas Model—Groups Of. An embodiment can be understood with reference to FIG. 47, showing a screen shot of a particular example. In the example, the paraphrase states the problem: 6 groups of ⅓, or 6×⅓. The starting value area model is used to display the starting value of ⅓ 4702. The product area model is used to organize 6 groups of the starting value. In this case, the value of ⅓ is regarded as a group, and 6 of those groups are placed in the product area model 4704. After they are all organized in the product area model, it becomes visually apparent that the product is 2 (4706.)

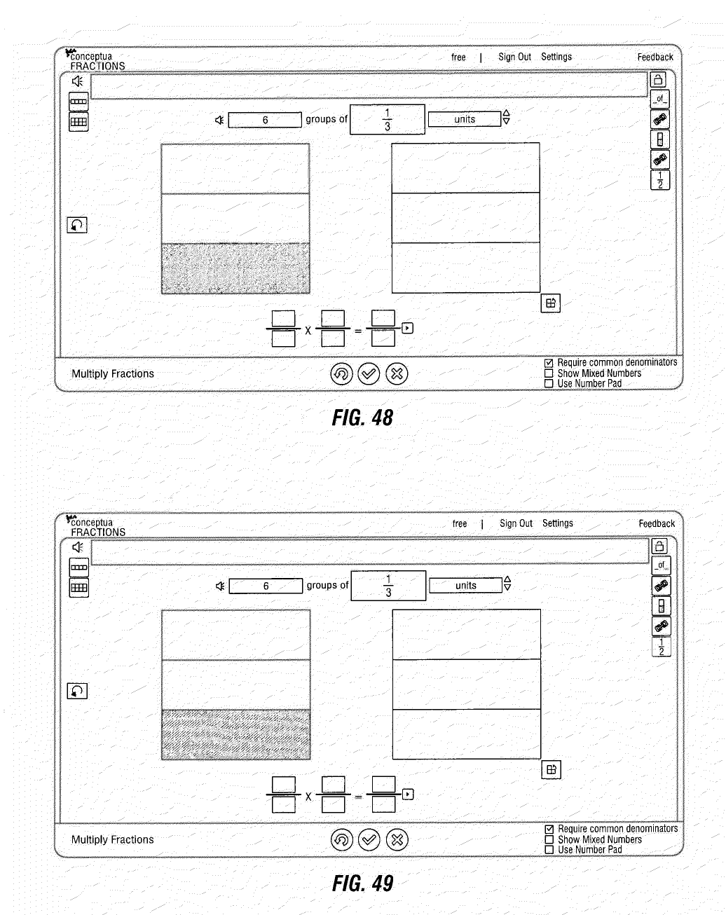

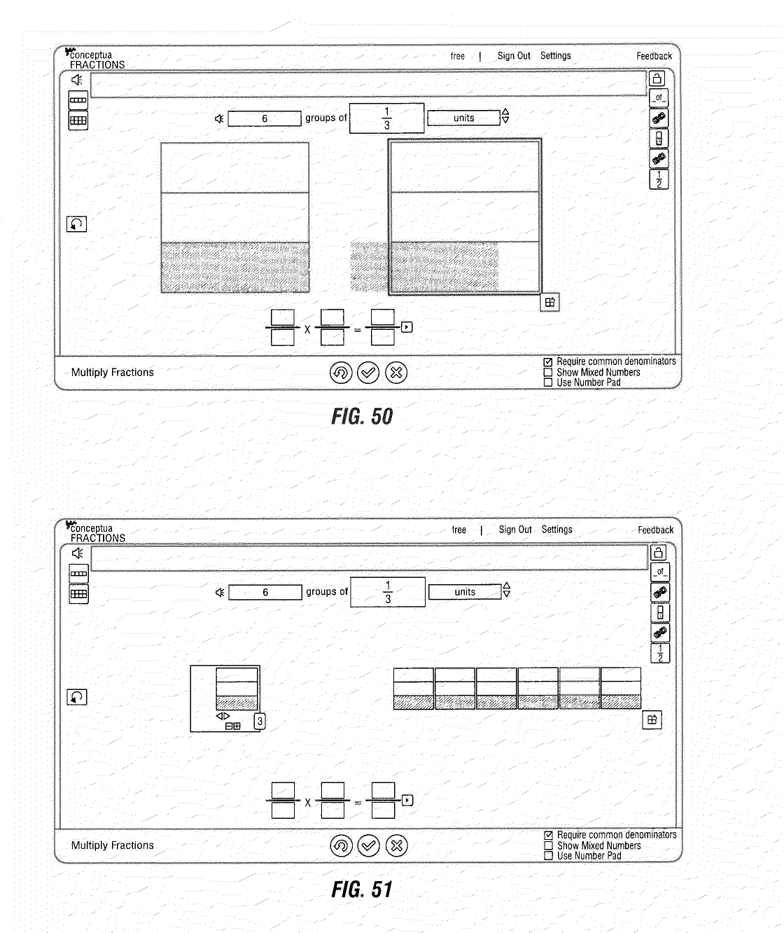

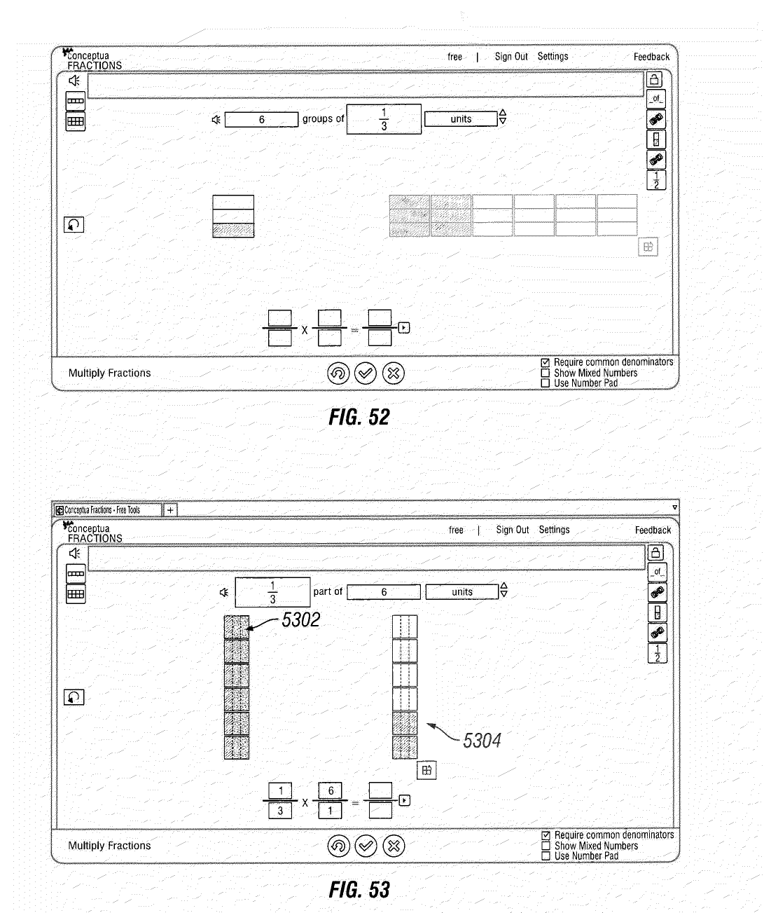

It should be appreciated that the model may be used flexibly. An embodiment may be understood with reference to FIGS. 48-52, showing a particular example groups of problem in accordance with an embodiment. The details depict one way to use the model by way of example only and are not meant to be limiting. When the two areas model is neither linked nor locked, the student must complete the model on their own, step by step. Following is the sequence of the example problem. The student divides the starting value area model into thirds and colors one of those thirds green to depict ⅓, as shown in FIG. 48. The student selects the model for ⅓, as shown in FIG. 49. The student drags the ⅓ piece to the product area model and repeats as many times until the correct amount of times has been achieved, as shown in FIG. 50. Upon dragging the 6th piece, the product area model has automatically recalibrated to depict 6 quantities of ⅓ each, as shown in FIG. 51. The student may use the reorganize button to make a clear display showing that 6 groups of ⅓ equals 2, as shown in FIG. 52.

Two Area Models—Parts Of. When the two areas model is used to depict a part of problem, it is used in a different manner than in the manner for the groups of problem as described hereinbelow. An embodiment can be understood by way of example, which is not meant to be limiting. This example can be understood with reference to FIG. 53. This example shows ⅓×6. The answer is identical to the problem above (6×⅓), because multiplication is a commutative operation. However, the reasons for this equivalence are not necessarily apparent to a student or teacher. The model is designed to show the reasoning behind the answer for ⅓×6. The starting value (6) is shown in the start value area model 5302. The multiplier is ⅓. The product (2) is shown in the product area model 5304. It should be appreciated that when the two areas model is neither linked nor locked, the student must complete the model on their own, step by step.

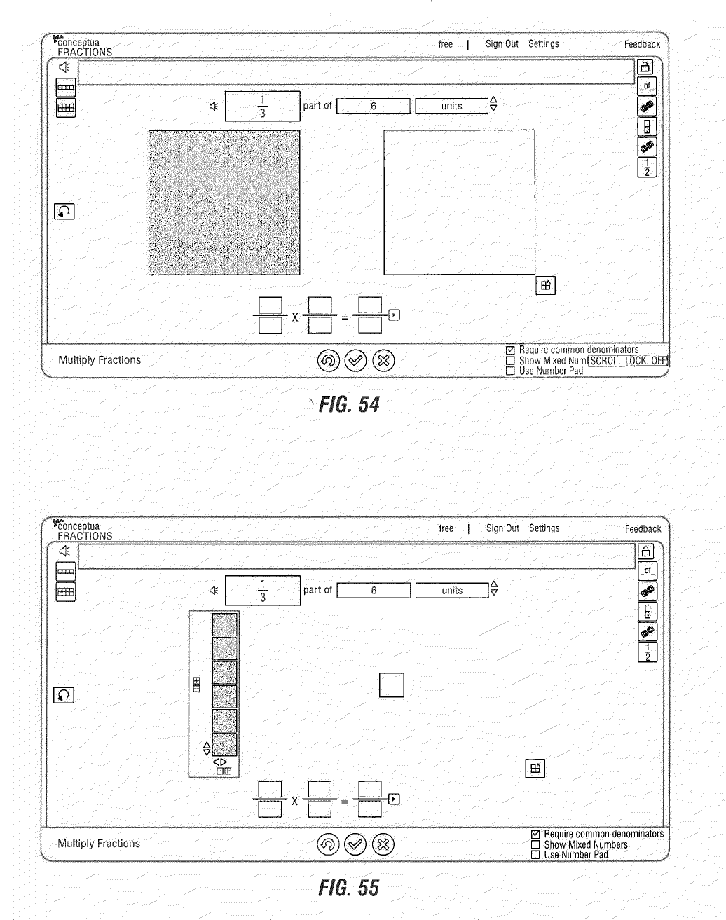

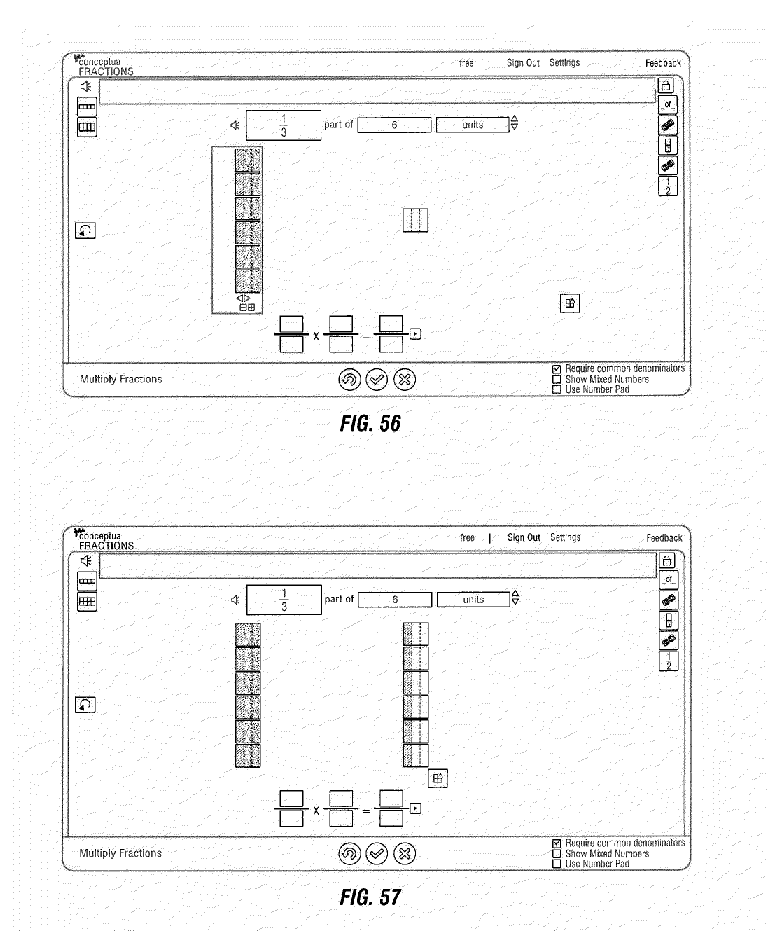

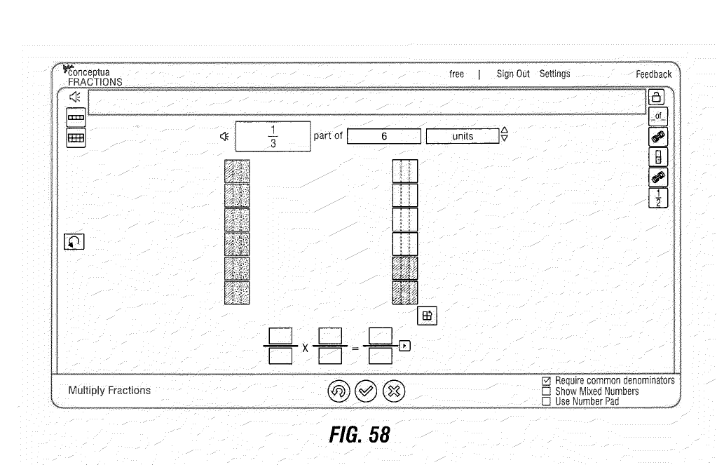

Following is an example sequence of using the two areas model, part of, according to an embodiment. For purposes of understanding, reference can be made to FIGS. 54-58. The student makes a model for 1 whole in the starting value area model, as shown in FIG. 54. The student repeats the creation of wholes in the starting value area model until they have made a total of 6. Both area models scale smaller to accommodate this quantity, as shown in FIG. 55. The student divides the 6 into 3 equal parts, and selects one of those equal parts, as shown in FIG. 56. The student drags the one part to the product area model. The model automatically re-renders to show 6 wholes, with one third of each shaded, as shown in FIG. 57. The student uses the rearrange button to group the shaded areas. It is now visually clear that ⅓×6=2, as shown in FIG. 58.

Operating the Two Areas Model. In an embodiment, the operation of the two areas model uses particular individual controllers to employ the model.

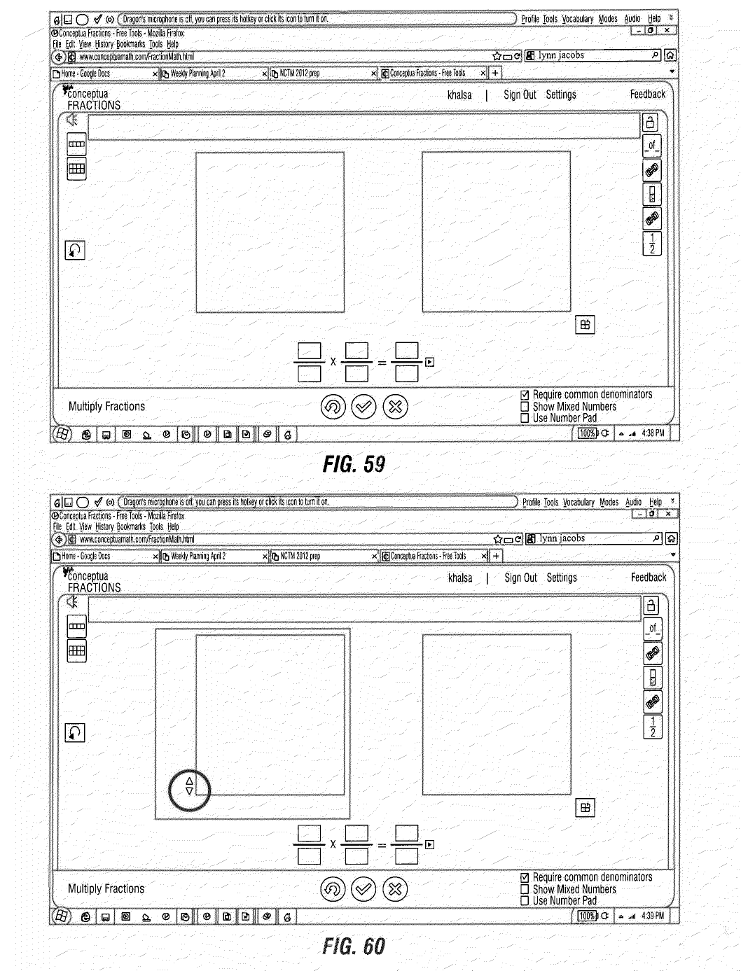

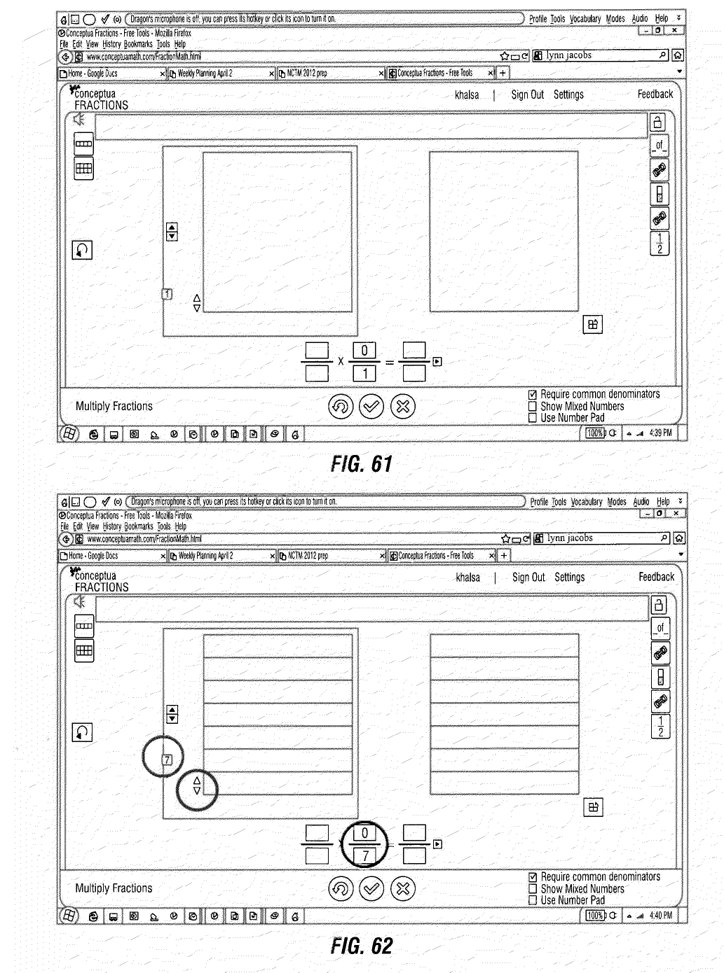

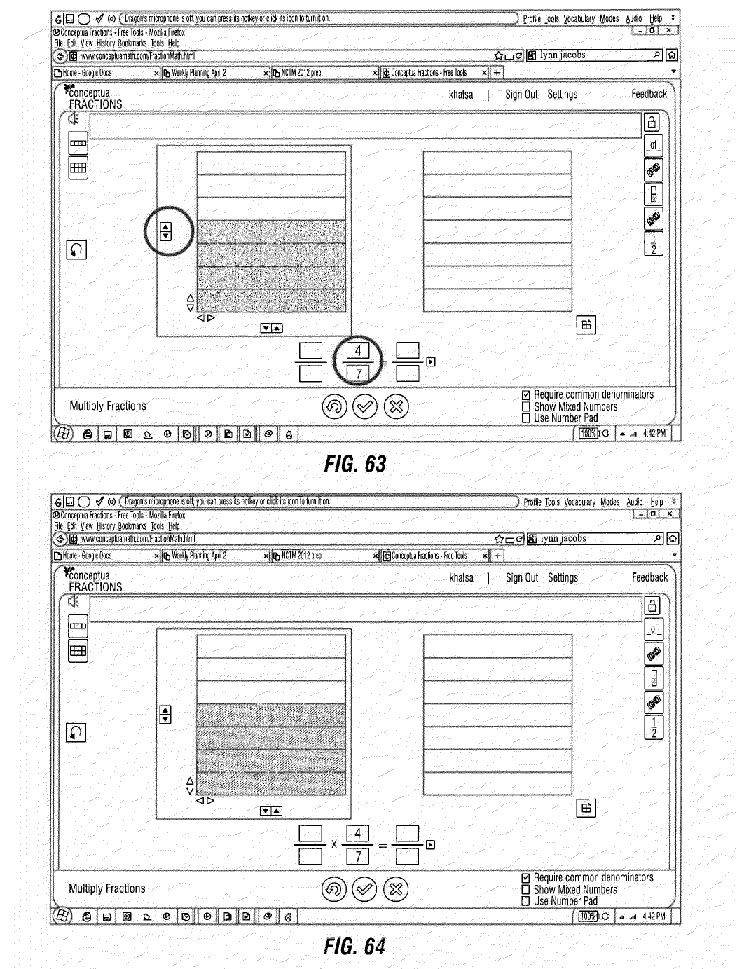

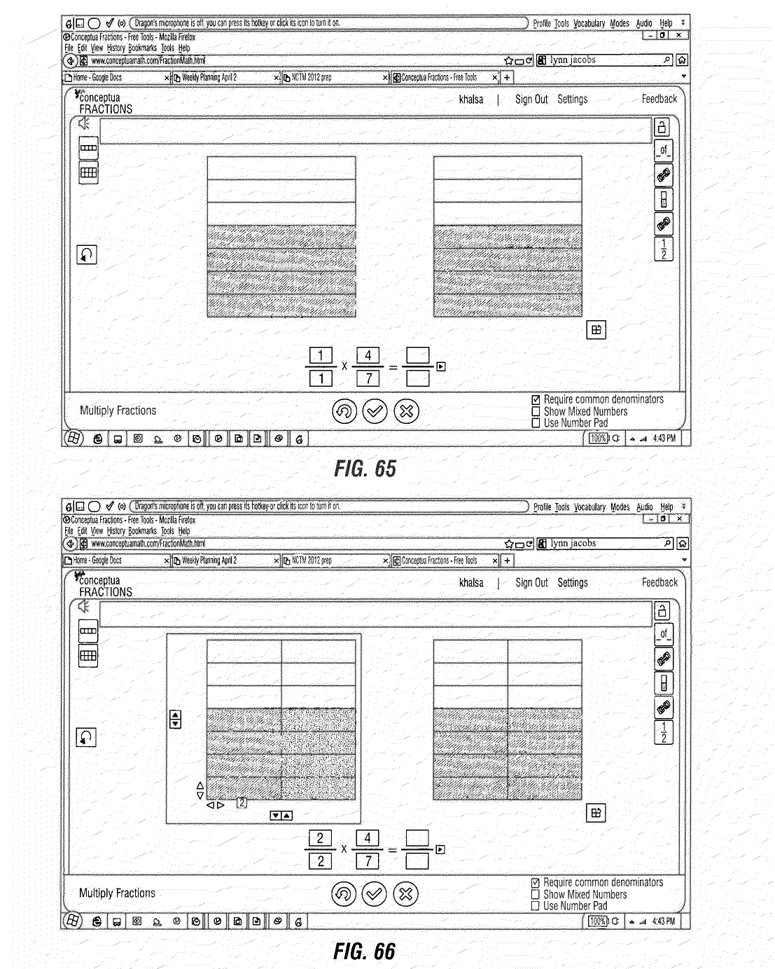

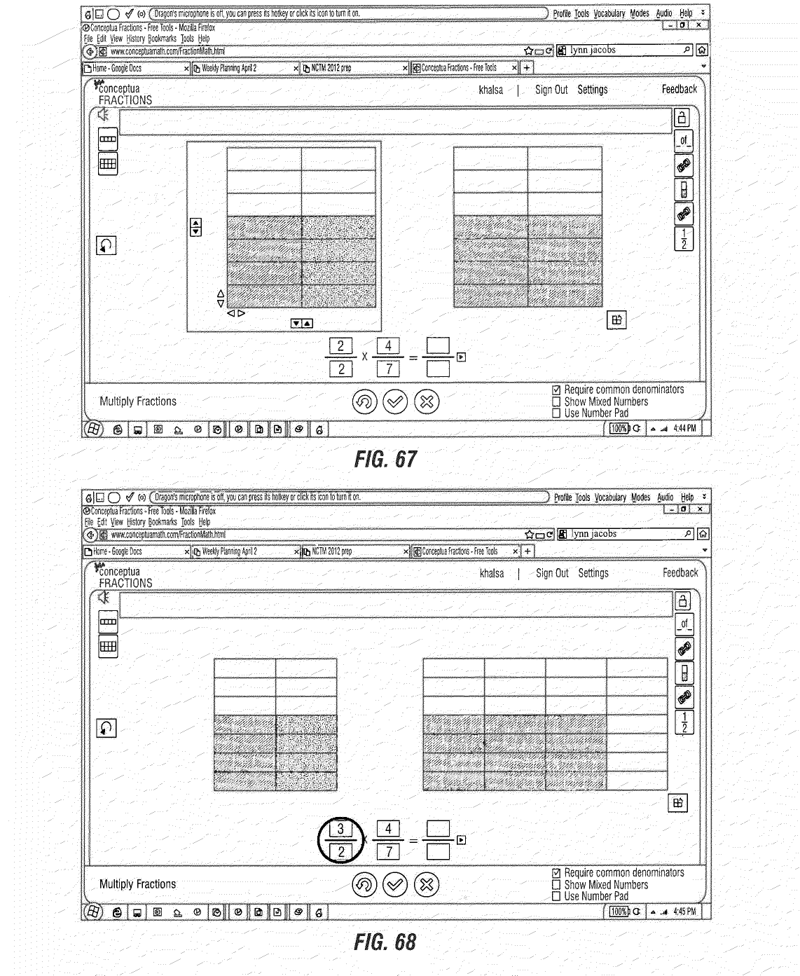

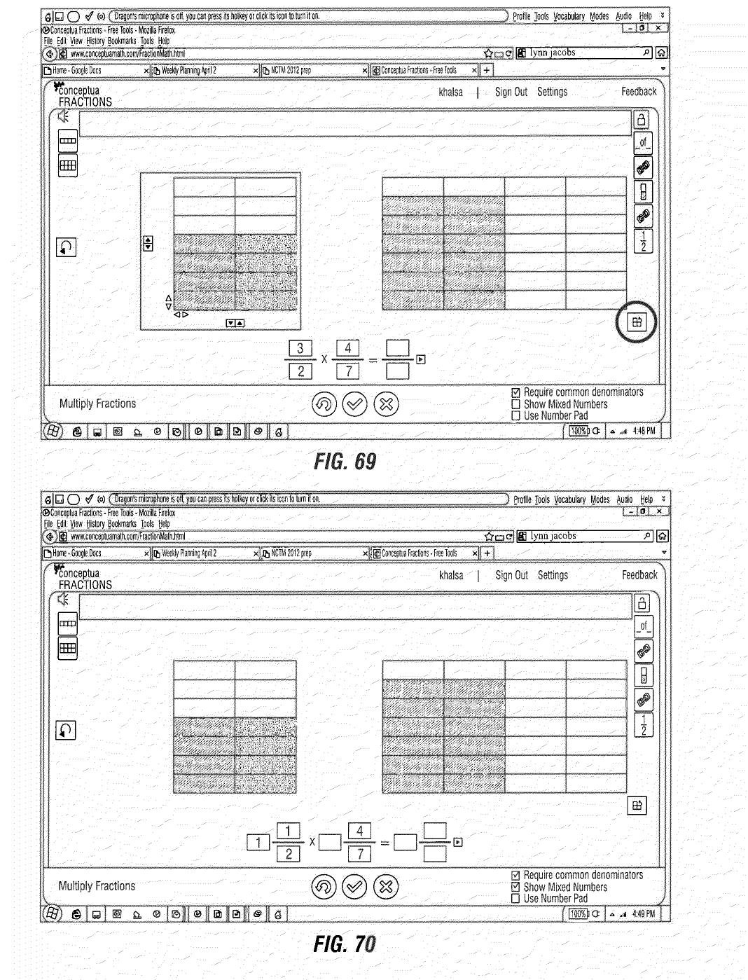

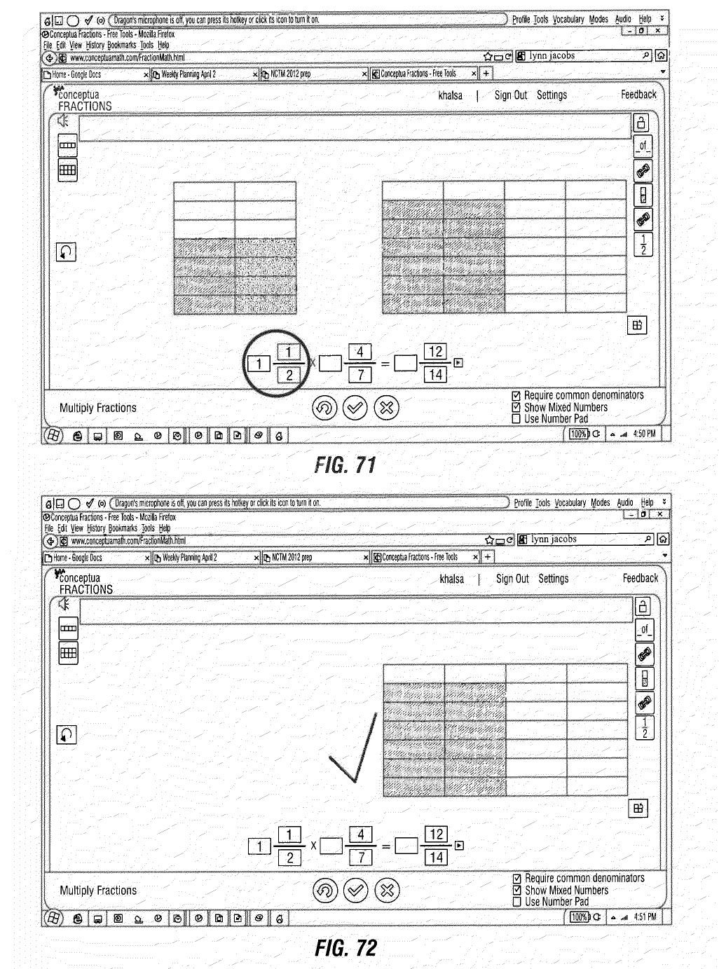

An embodiment of the operations for a groups of problem can be understood with reference to FIGS. 59-72. It should be appreciated that the particular details are meant by way of example only and are not meant to be limiting. To begin with, the controls do not appear, as shown in FIG. 59. The controls appear when the user rolls the cursor over the model, as shown in FIG. 60. The user clicks on a controller and two area models appear, as shown in FIG. 61. The user clicks on a controller to segment the starting value number line into seven equal parts. Given that linking is turned on, the equation populates the starting value with a denominator of 7, as shown in FIG. 62. The user clicks on a controller to shade four of the seven equal parts. The starting value shaded model now represents 4/7. Given that linking is turned on, the equation populates the starting value with a numerator of 4. The starting value is now represented as 4/7, as shown in FIG. 63. The user clicks on the shaded model in the starting value area model to select it, as shown in FIG. 64. The user drags the model, representing 4/7, to the product area model. The user has now represented 1× 4/7. The user now needs to add another ½× 4/7 to the product area model in order to represent the product, as shown in FIG. 65. The user clicks on a controller to segment the starting value shaded model into 2 equal parts, or halves. This is because the multiplier is 1½. In order to select ½ more of the starting value shaded model, that model must be segmented into halves. At the same time, the denominator of both the starting value and product area models have been segmented to match the denominator of the starting value shaded model. The denominator is 14, as shown in FIG. 66. The user clicks on the starting value shaded model in order to select one of the two equal parts. This model now accurately depicts ½ of 4/7, as shown in FIG. 67. The user drags the selected portion of the starting value shaded model over to the product area model. The model on the right now shows 1½ groups of 4/7. Given that linking is turned on, the equation populates the multiplier with a value of 3/2, as shown in FIG. 68. The user clicks on the rearrange button. The two area models have already been segmented 14 equal parts. It is visually apparent that the shaded model in the product area model occupies 12 of those 14 equal parts, as shown in FIG. 69. Show mixed numbers has been enabled. The equation now reads 1½× 4/7, as shown in FIG. 70. The user enters the product of the equation: 12/14. The model has served its purpose. It has demonstrated that 1½× 4/7= 12/14, as shown in FIG. 71. Upon selecting the check work button, two things take place. First, a green mark appears, indicating that the equation is correct and that it matches the model. Second, the starting value area model disappears, leaving the product area model in place. The purpose for this is to provide the user with a clear visual indication of the answer, as shown in FIG. 72.

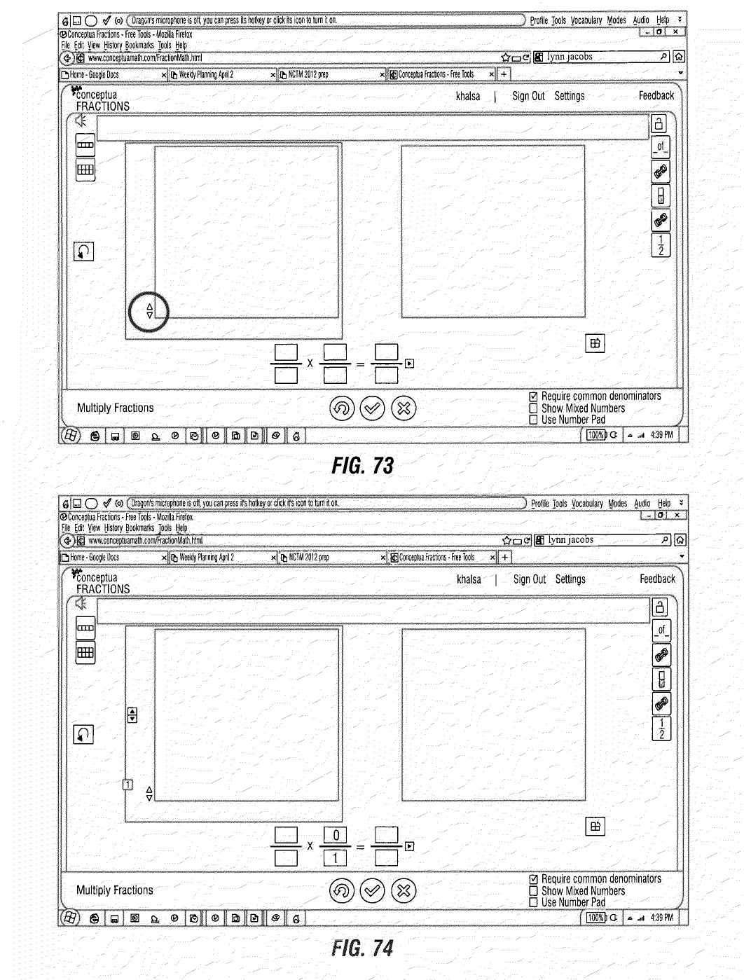

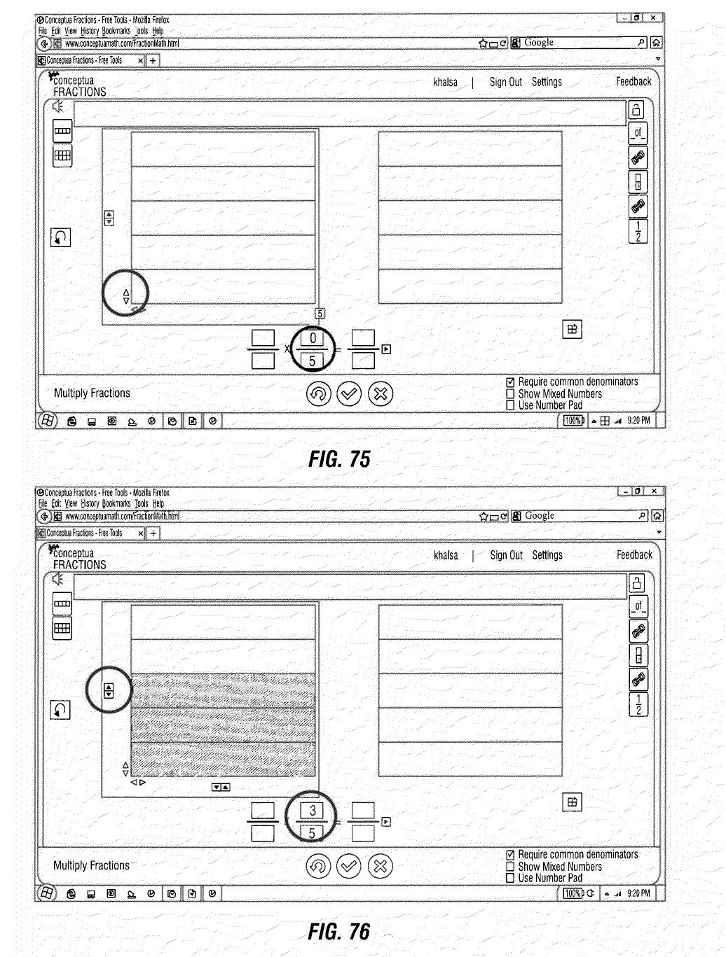

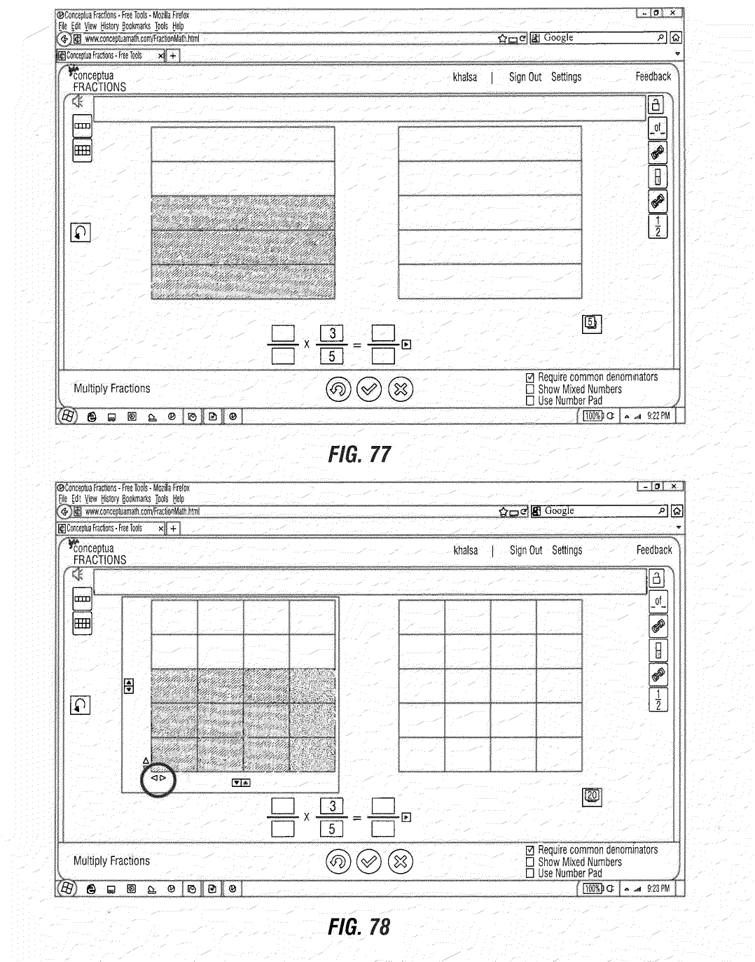

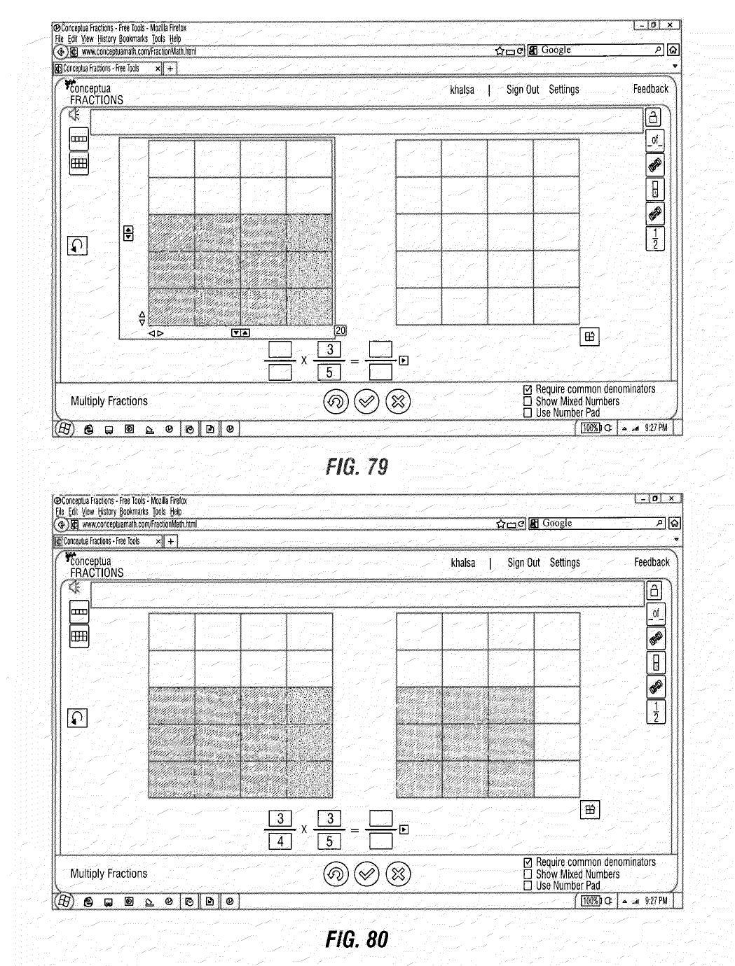

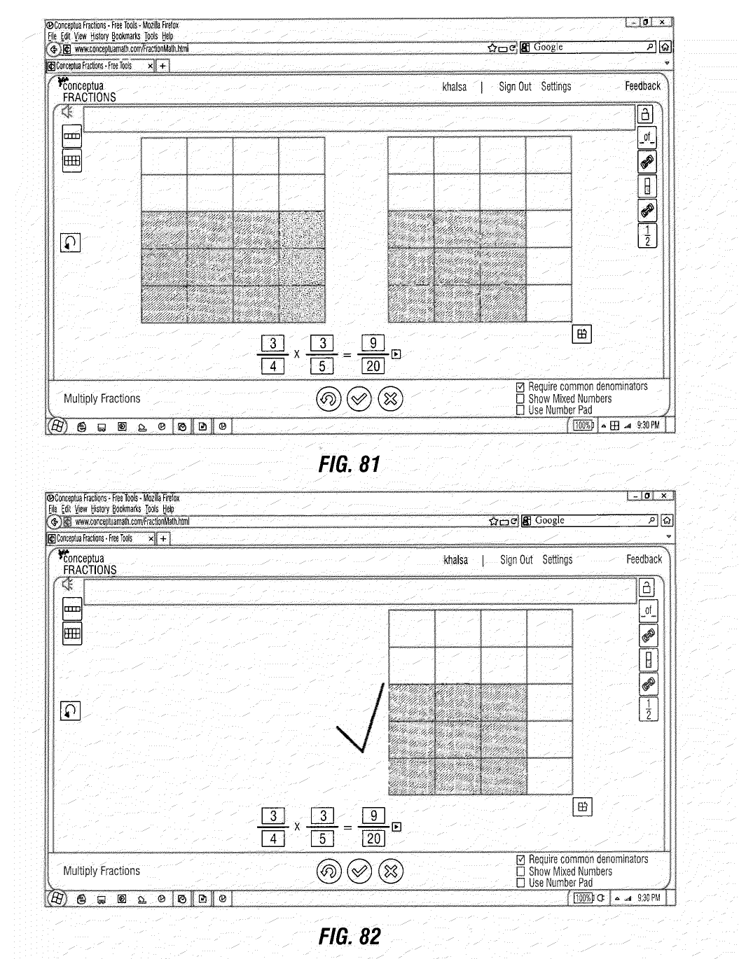

An embodiment of the operations for a part of problem can be understood with reference to FIGS. 73-82. It should be appreciated that the particular details are meant by way of example only and are not meant to be limiting. To begin with, the controls do not appear (not shown). The controls appear when the user places the cursor over the model, as shown in FIG. 73. The user clicks on a controller and two area models appear, as shown in FIG. 74. The user clicks on a controller to segment the starting value area model into five equal parts. Given that linking is turned on, the equation populates the starting value with a denominator of 5, as shown in FIG. 75. The user clicks on a controller to shade three of the five equal parts. The shaded model now represents ⅗. Given that linking is turned on, the equation populates the starting value with a numerator of 3. The starting value is now represented as ⅗, as shown in FIG. 76. The user clicks on the shaded model in the starting value area model to select it, as shown in FIG. 77. The user clicks on a controller to segment the starting value area model into equal parts. At the same time, the denominator of both the starting value and product area models have been segmented to match the denominator of the starting value shaded model. The denominator is 20, as shown in FIG. 78. The user clicks on the shaded model in order to select three of the four equal parts. This model now accurately depicts three fourths of ⅗, as shown in FIG. 79. The user drags the selected portion of the starting value shaded model over to the product area model. The model in the product area model now shows 9/20. Given that linking is turned on, the equation populates the multiplier with a value of ¾, as shown in FIG. 80. The user enters the product of the equation: 9/20. The model has served its purpose. It has demonstrated that ¾×⅗ equals 9/20, as shown in FIG. 81. Upon selecting the check work button, two things take place. First, a green mark appears, indicating that the equation is correct and that it matches the model. Second, the starting value area model disappears, leaving the product area model in place. The purpose for this is to provide the user with a clear visual indication of the answer, as shown in FIG. 82.

### Various Representations of the Tool

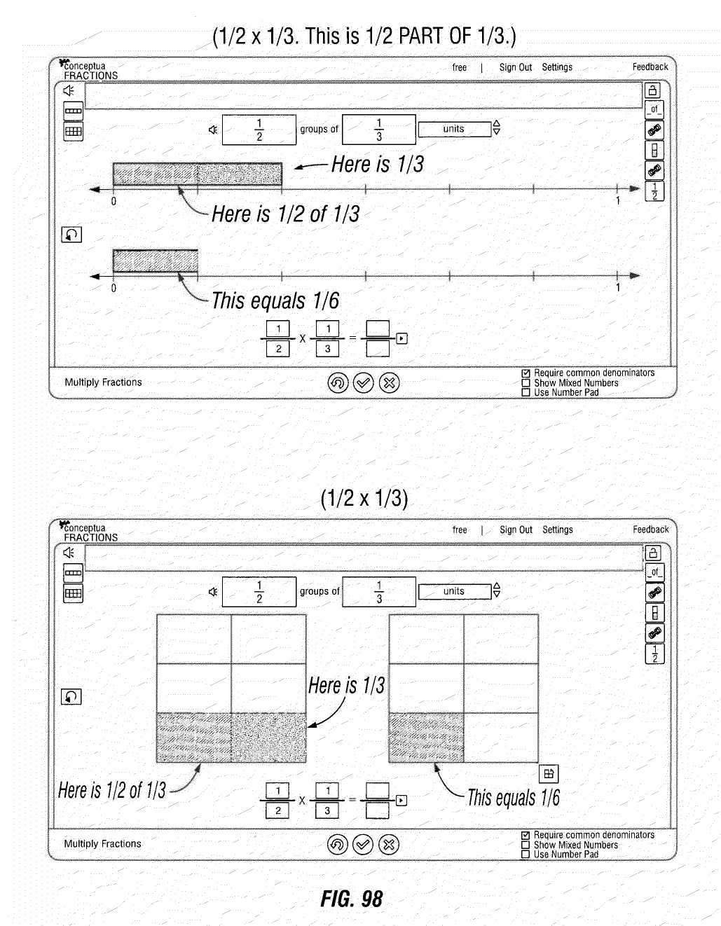

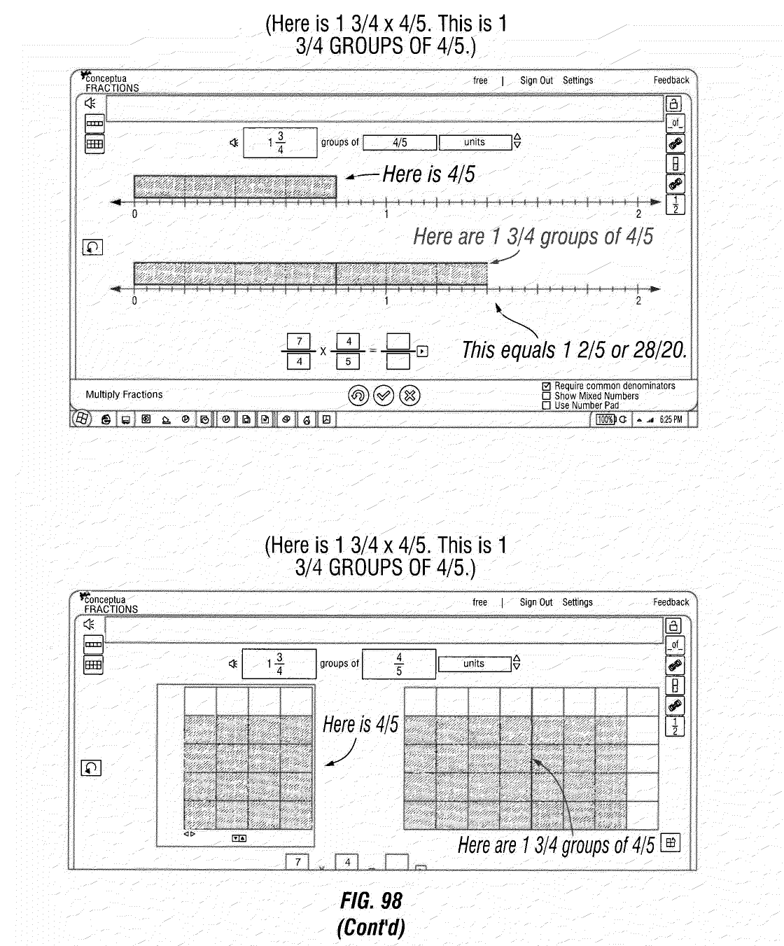

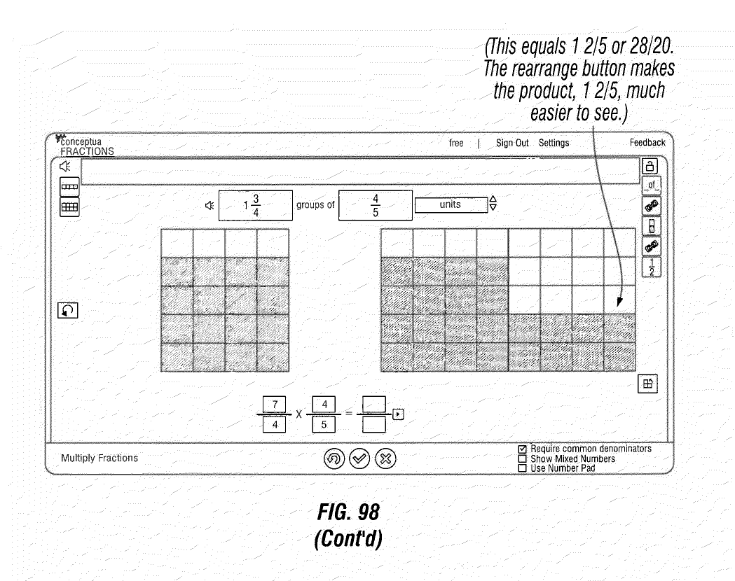

In accordance with embodiments herein, various visual representations of problems to be solved by tools are provided. FIG. 98 shows examples of representations of two different problems. The first interface shows ½×⅓ as a part of problem using the two number line model. The second interface shows the same problem as a groups of problem using the two areas model. The third interface shows 1¾×⅘ as a groups of problem using the two number line model. The fourth and fifth interfaces show the same problem, 1¾×⅘, as a groups of problem using the two areas model.

### Representation Layer—The Equation

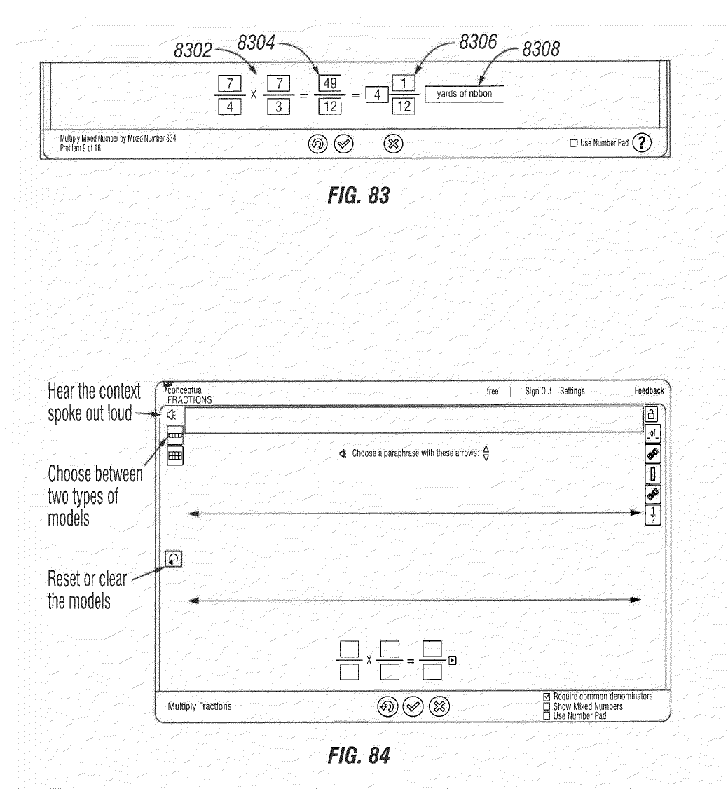

In an embodiment, the equation layer has one or more portions. For example, in the multiplying fractions tool, the equation layer has five portions. The embodiment can be understood with reference to FIG. 83. The five portions are as follows: multiplier, starting value 8302; product 8304; restated product 8306; and unit 8308.

Some features of the equation layer are presented below. It should be appreciated that such list is by way of example only and is not meant to be limiting:
The restated product can be hidden or shown.
The multiplicand, multiplier and product can be linked to the models independently. If the models are linked to the paraphrase, then the multiplicand, multiplier and product can be linked to the paraphrase independently. This means that by entering information into the paraphrase or configuring the models, the user can affect a linked change in any one of these three text fields (the multiplicand, multiplier or product) without affecting another of the three.
   The multiplicand and multiplier can be independently linked from the equation to the model whereby changes in the equation are propagated to the corresponding values in the model except that unlinked values in the model are not changed.
   The multiplicand, multiplier and product and be independently linked from the model to the equation such that changes in the model are propagated to the corresponding values in the equation except that unlinked values in the equation are not changed.
   The multiplicand and multiplier can be linked from the equation to the corresponding values in the paraphrase through linkages from the equation to the model and from the model to the paraphrase.
   The multiplicand and multiplier can be linked from the paraphrase to the corresponding values in the equation though linkages from the paraphrase to the model and from the model to the equation.
   The units field can be linked from the equation to the paraphrase whereby changes to the equation's unit field are propagated to the paraphrase's unit field.
   The units field can be linked from the paraphrase to the equation whereby changes to the paraphrase's unit field are propagated to the equation's unit field.
Any of the separate fields (numerators, denominators, whole numbers, or units) can be pre-populated by an author.
Any of the separate fields (numerators, denominators, whole numbers, or units) can be locked by an author, and therefore un-editable by the student or user.
The equation is checkable in two ways. First, the numbers in the equation must correspond to the values in the model and the paraphrase. If they do not, the differences can be used to provide strategic feedback to the student. Second, the numbers in the equation must correctly solve the multiplication problem. If they do not, then the student can be given strategic feedback.
These levels of checking can be modified by authors as part of the scaffolding mechanism. For instance, the author can require that the product is simplified or not or if the restated product is shown, that is be simplified or not.
The unit is checkable.
The student may populate the unit field in the equation either by dragging text from the context or paraphrase, or by typing directly into the unit field.

### Controls—Tool Mode

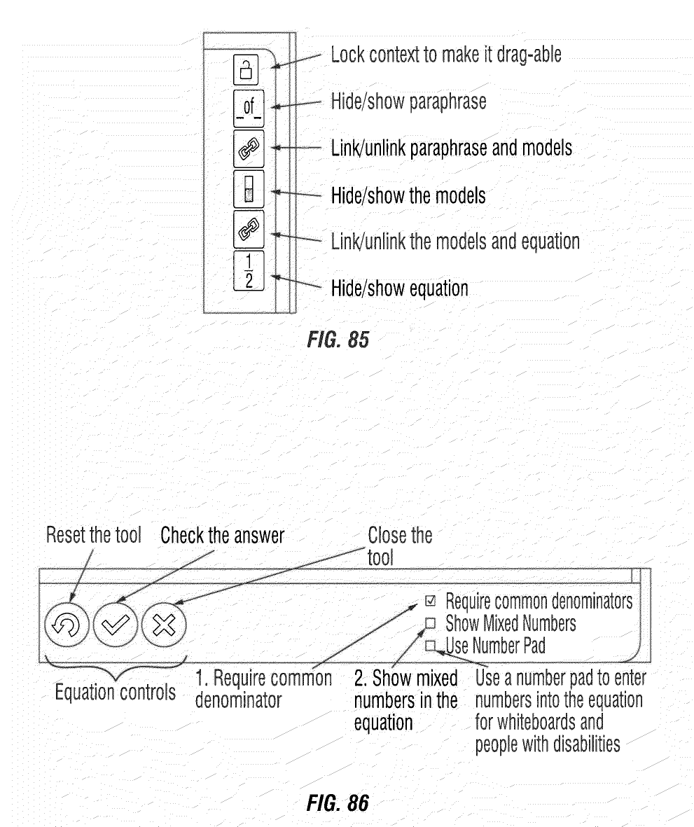

An embodiment provides a tool mode for operation. Tool mode is what it says, it is the mode in which the application is used as a tool. For example, the tool mode is the mode that the public encounters when operating the multiplying fractions tool. Tool mode offers but is not limited to offering the following functionality: hearing the context spoken out loud; choosing between types of models; locking context; hiding and showing paraphrase; linking and unlinking paraphrase and models; hiding and showing the models; linking and unlinking the models and the equation; hiding and showing the equation; resetting the tool; checking the answer; closing the tool; requiring common denominator; showing mixed numbers in the equation; and using a number pad to enter numbers into the equation for whiteboards and for people with disabilities. As an example, FIG. 84 shows the functions of the buttons on the left side of the tool, according to an embodiment. As an example, FIG. 85 shows the functions of the buttons on the upper right side of the tool, according to an embodiment. As an example, FIG. 86 shows the functions of the buttons on the bottom of the tool, according to an embodiment.

### Authoring Mode—Educational Advantages

In an embodiment, a user is enabled to create lessons using the tool. For ease of understanding, such user is referred to herein as an author. In the embodiment, the author may construct individual study objects, or problems, for a student to solve. In an embodiment, one or more problems may be sequenced together as sets. That is, each set comprises a lesson. In the embodiment, many variables are under the author's control and, thus, provide the ability for the author to create lessons that carefully scaffold instruction, e.g. in the multiplication of fractions.

In an embodiment, authoring mode is enabled through the use of a dedicated spreadsheet. The author uses the spreadsheet to construct the individual study objects or problems for the student to solve. It should be appreciated that the authoring spreadsheet is a specific implementation; other authoring workflows, such as templates, wizards and wysiwyg interfaces can be used, as well.

In an embodiment, the author enters variables for each of the four layers: Context, Paraphrase, Models, and Equation. For each layer, a number of variables may be controlled. Such variables may include but are not limited to:
Which layers are shown, and which, if any, are hidden;
The text and numbers entered into the context;
The words, phrases, and numbers that can be selected, e.g. as the starting value, the multiplier, and the unit;
The indicators for which words, phrases, and numbers are the correct choices, e.g. as the starting value, the multiplier, and the unit;
The type of paraphrase to be displayed on the screen, e.g. groups of, part of, or both;
The paraphrase that is correct;
The type of model to be used;
Whether the model is linked to the paraphrase;
Whether the model is linked to the equation;
Which, if any, part of the model are pre-populated and locked in place;
Which, if any, part of the model are populated by the content of the paraphrase and locked in place once the paraphrase is articulated;
How much of an equation is displayed on the screen, e.g. nothing, the simplified product only with the units, the simplified product only, the product (before it is simplified), the starting value, the multiplier;
Which, if any, part of the equation are:
   Pre-populated or empty; and
   Locked or unlocked (editable or not);
Whether mixed number are enabled; and
The specific, custom feedback that students will receive upon making errors.

These variables and more enable a number of pedagogical choices that are very important to educate students about mathematical operations, e.g. the multiplication of fractions.

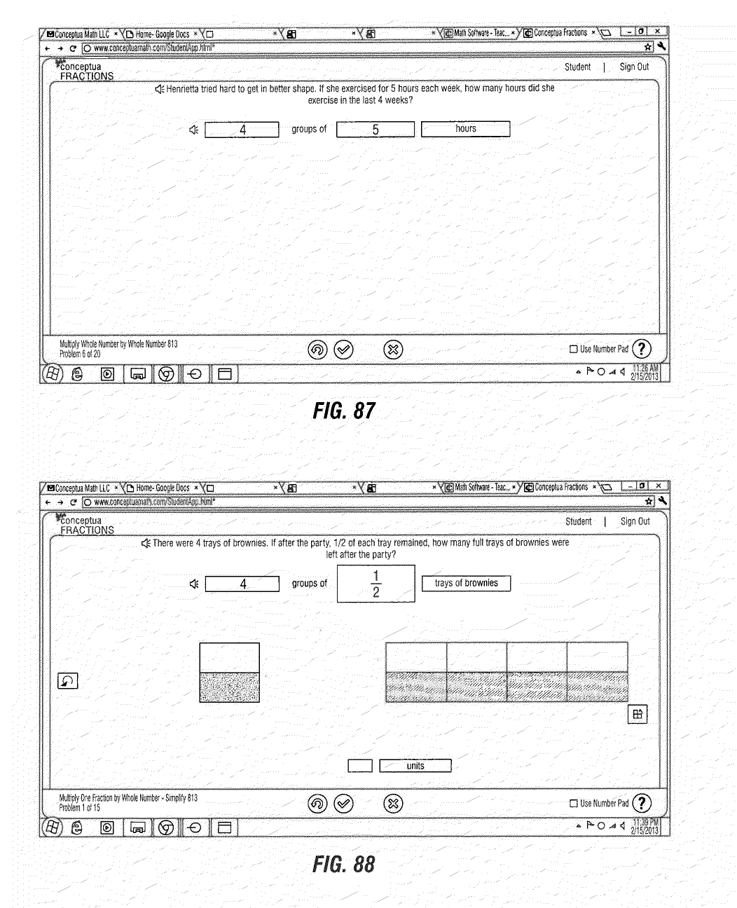

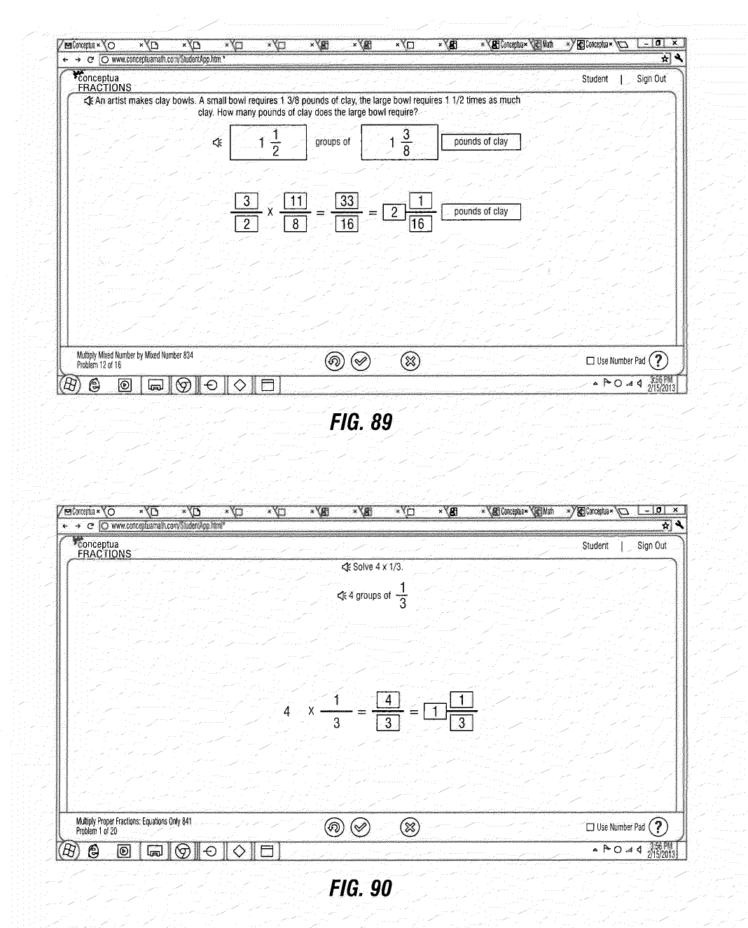

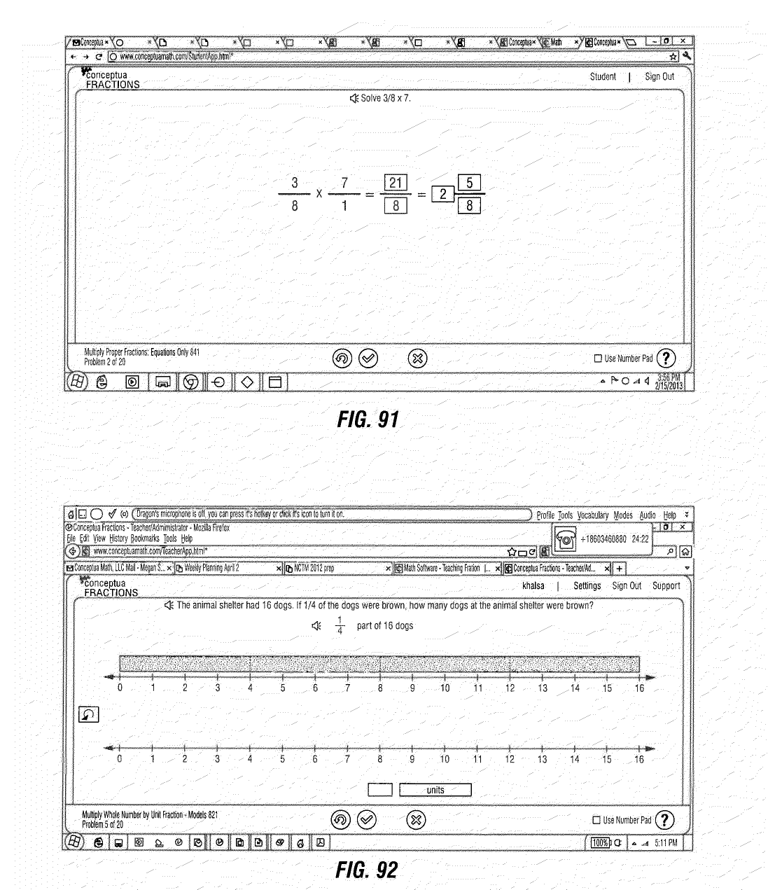

Examples of Authoring Variables that Educate Students. FIGS. 87-91 show examples of hiding and showing layers in accordance with embodiments herein. Only the context and paraphrase are shown. This allows students to focus on learning how to paraphrase, as shown in FIG. 87. Only the context, paraphrase, and models are shown, along with the product and units. This allows students to learn how representing the paraphrase with models can lead directly to an answer without the need for computation, as shown in FIG. 88. Only the context, paraphrase, and equation are shown. This allows students to learn to compute a product directly from being able to state and understand the paraphrase, as shown in FIG. 89. Only the paraphrase and equation are shown. The allows students to learn to compute based solely upon understanding the paraphrase, as shown in FIG. 90. Only the equation is shown. This allows students to learn to compute, without any other prompts, visual cues, or context, as shown in FIG. 91.

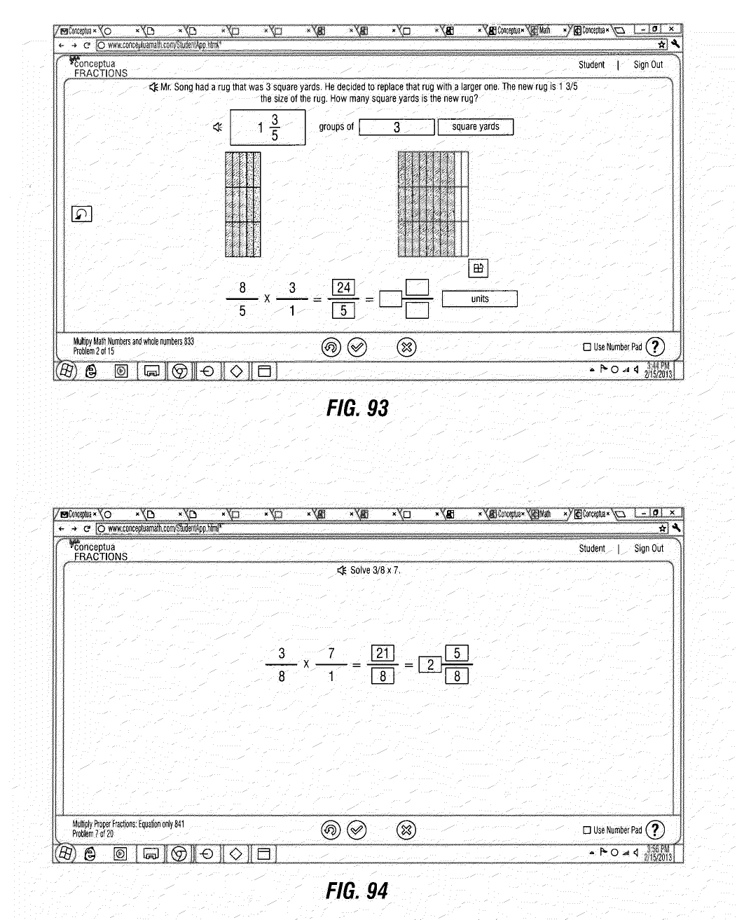

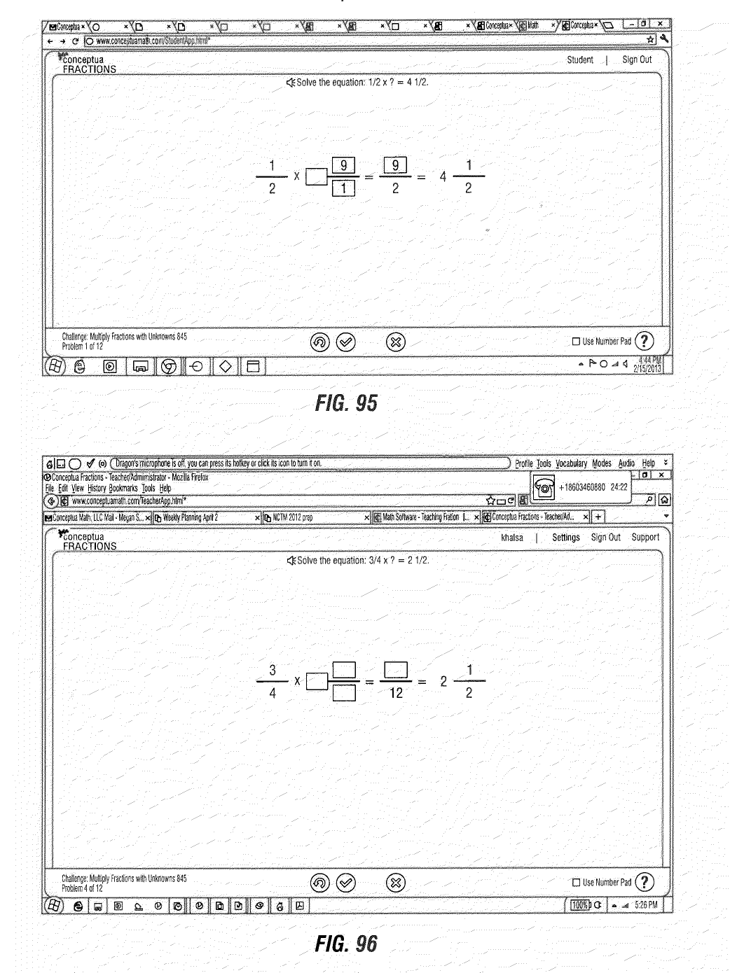

FIGS. 92-96 show examples of pre-populating and locking content within layers in accordance with embodiments herein. The starting value is pre-populated, locked, and segmented into fourths. The student will learn to drag one fourth of 16 to the product number line in order to learn that ¼×16=4, as shown in FIG. 92. As the student completes the models, the starting value, multiplier, and product of the equation are automatically entered and locked. The student's job is to re-state the product in simple terms and add the unit, as shown in FIG. 93. The multiplier and starting value are locked and provided to the student. The student's job is to compute both the product and the simplified or restated product, as shown in FIG. 94. The multiplier and simplified or restated product are both pre-populated and locked. The student must fill in the starting value and the product, as shown in FIG. 95. The multiplier and simplified or restated product are both pre-populated and locked. So is the denominator of the product. The student must fill in the starting value and the numerator of the product, as shown in FIG. 96.

### Exemplary Embodiments—Summary

One or more exemplary embodiments are provided by, but not limited to, any combination of the following structures and functionality of the context, paraphrase section, model section, and equation section, each section depicted in summarized form.

### Context

The context section may be hidden or shown independently from the other sections.
The context section may be locked or unlocked independently from the other sections.
A context is words, phrases, sentences, numbers and mathematical symbols that state or describe a mathematical problem.
When the context field is unlocked, a user can enter and delete text and numbers via typing or other method provided by the underlying operating system, e.g. voice-to-text.
When the context field is locked, a user cannot enter and delete text or numbers and the context can be used as a source of words, phrases or numbers that can be moved to fields in the paraphrase and/or the equation.
When the context is locked, words, phrases and numbers can be selected with a single selection, e.g. click or touch, and dragged from the context and dropped into fields of the paraphrase or the equation.
   When selecting numbers for such a drag and drop operation, the logic parses out numeric values, such integers, fractions and floating point numbers and drags the resulting numeric value. For instance, the text “1½” is parsed into the mixed fraction one and one half if the user clicks (or touches) anywhere within the text from the initial one to the final two inclusive.
   When selecting words for such a drag and drop operation, the logic parses out continuous alphanumeric characters surrounded by whitespace and/or punctuation and drags the resulting word as text.
   When selecting phrases for such a drag operation, the logic consults a prescribed list of phrases and parses out instances of a phrase surrounded by whitespace and/or punctuation and drags the resulting phrase as text.

### Paraphrase Section

The paraphrase section may be hidden or shown independently from the other sections.
The paraphrase section, when visible, shows a single prescribed paraphrase or may offer two or more paraphrases from which the user can choose.
   For a multiplication problem, there are two paraphrases that may be offered
      “Groups Of” is used for multipliers with magnitude greater than or equal to one.
      “Parts Of” is used for multipliers with magnitude less than one.
The paraphrase is a combination of text, numbers and symbols that reduce a mathematical problem, such as presented in the context section, into a single, simplified phrase or sentence the parts of which can be directly and predictably expressed as a mathematical model and/or an equation.
   The paraphrase has fields that correspond to values in the model or equation;
      For a multiplication problem, the paraphrase contains two numeric fields that correspond to values of the model; the multiplier and multiplicand.
      For a multiplication problem, the paraphrase contains two numeric fields that correspond to numeric values of the equation; the multiplier, and multiplicand and a textual field that corresponds to the equation units.
   The paraphrase combines these numeric and textual fields with non-editable text to form a simplified statement of the mathematical problem, such as 3 groups of 5 or ½ part of 4.
The fields of the paraphrase may be independently locked or unlocked.
   The unlocked fields of the paraphrase can be directly edited by the user by typing into them.
   The unlocked fields of the paraphrase may be changed by selecting text or numbers in the context and moving such from the context to a field in the paraphrase.
      Such change could be done with copy and paste operation.
      Such change could be done by a drag and drop operation.
   The Locked fields of the paraphrase may not be directly editable by the user by typing into such fields or by copy and paste or by drag and drop operations.
The fields of the paraphrase can be linked to corresponding fields of a model or an equation such that:
   Changing a field in the paraphrase changes the corresponding field of a model or equation, regardless of whether the model or equation field is locked or unlocked.
   Changing a field in the model or the equation changes the corresponding field in the paraphrase regardless of whether the paraphrase field is locked or unlocked.
Paraphrase Answer Checking
When the paraphrase section is hidden, it is not checked. When the paraphrase is visible, the following states may be checked;
   The visible fields of the paraphrase must not be empty.
   The numeric fields of the paraphrase must contain a valid number. For a multiplication problem, the numeric fields are the multiplier and the multiplicand.
   The numeric fields of the paraphrase must have same value of the corresponding fields of the model, if visible, and of the equation, if visible.
      For a multiplication problem, the multiplier and multiplicand fields of the paraphrase must have the same value as the multiplier and multiplicand in the model, if it is the model is visible.
      For a multiplication problem, the multiplier, multiplicand and units fields of the paraphrase must have the same value as the multiplier and multiplicand in the equation, if those fields are visible in the equation.
   The choice of paraphrase, either “Groups Of” or “Parts Of”, can be checked against the magnitude of the multiplier. If the magnitude of the multiplier is greater than or equal to one, then the “Groups Of” paraphrase is correct. If the magnitude of the multiplier is less than one, then the “Parts Of” paraphrase is correct.
   If a correct value is specified for the multiplier, the multiplier in the paraphrase must have the same value as the correct value.
   If a correct value is specified for the multiplicand, the multiplicand in the paraphrase must have the same value as the correct value.
   If a correct value is specified for the units, the units in the paraphrase must have the same value as the correct units.

### Model Section

The model section may be shown or hidden independently of the other sections and the context field.
The model has an initial state where no multiplicand or multiplier has been created. This can be called the empty state.
The model has a multiplicand value and a multiplier value. Together, these are used to implicitly calculate the resulting product field.
The initial values for the multiplicand and multiplier can be independently set by an author.
There are two models that a user can choose from;
   The number line model, which uses horizontal bars over a number line to show the multiplicand, multiplier and product.
   The area model, which uses rectangles to show the multiplicand, multiplier and product.
The author may limit a user to a subset of the models.
The author may choose the model that is initially shown.
The multiplicand and multiplier fields can be independently locked by an author, such that a user cannot directly change the values, except that the values can be changed through linking to other sections.
The model's multiplicand and multiplier fields can be independently linked from the paraphrase to the model, such that if any of those fields are changed in the paraphrase, the values are propagated to the corresponding fields of the model.
The model's multiplicand and multiplier fields can be independently linked from the model to the paraphrase such that if any of those fields are changed in the model, the values are propagated to the corresponding field(s) in the paraphrase.
The model's multiplicand and multiplier fields can be independently linked from the equation to the model, such that if any of those fields are changed in the equation, the values are propagated to the corresponding fields of the model.
The model's multiplicand, multiplier and product fields can be independently linked from the model to the equation such that if any of those fields are changed in the model, the values are propagated to the corresponding field(s) in the equation.
Answer Checking of the Equation
   The fields of the model are not checked if the model is hidden.
   Individual fields of the equation may be marked for checking or not checking independently.
   When the model is visible and for those fields that are marked as checked;
      If the field's value is not greater than zero, then this is an error and the user is given feedback that indicates the field is empty.
      The multiplier and multiplicand fields must have the same value as the corresponding fields in the paraphrase, if those fields are visible in the paraphrase and are marked as checked in the paraphrase.
      The multiplier, multiplicand, and product fields must have the same value as the corresponding fields in the equation, if those fields are visible in the equation and are marked as checked in the equation.
      If a correct value is specified for the multiplier, the multiplier in the model must have the same value as the correct value.
      If a correct value is specified for the multiplicand, the multiplicand in the model must have the same value as the correct value.

### Equation Section

The equation section contains 4 numeric fields; the multiplicand, the multiplier, the product and the restated product, and one text field, the units.
The default initial state for all fields is empty.
Individual parts of the numeric fields, the whole part, the numerator, and the denominator can be independently set with initial values by an author.
The equation sections may be hidden or shown independently from the other sections and the context.
Individual fields in the equation may be hidden or shown independently.
Individual parts of the numeric fields, the whole part, the numerator, and the denominator can be independently locked by an author such that a user cannot directly edit the values, except that the values can be changed by linking to other sections.
Answer Checking of the equation
   Individual fields of the equation may be marked for checking or not checking independently.
   Hidden fields are not checked.
   For those fields that are marked as checked and are visible;
      A field must not be empty, except that the restated product, if it is empty, may be treated as not checked.
      Numeric fields must contain a valid number.
      The numeric fields of the equation must have same value of the corresponding fields of the model, if visible, and of the paraphrase, if visible.
         For a multiplication problem, the multiplier, multiplicand and product fields of the equation must have the same value as the multiplier, multiplicand and product in the model, if it is the model is visible.
         For a multiplication problem, the multiplier, multiplicand and units fields of the equation must have the same value as the multiplier, multiplicand and units fields in the paraphrase, if those fields are visible in the paraphrase.
      If a correct value is specified for the multiplier, the multiplier in the equation must have the same value as the correct value.
      If a correct value is specified for the multiplicand, the multiplicand in the equation must have the same value as the correct value.
      If a correct value is specified for the units, the units in the equation must have the same value as the correct units.
      The numbers in the equation must satisfy the mathematical relationships of multiplier×multiplicand=product.

### An Example Machine Overview

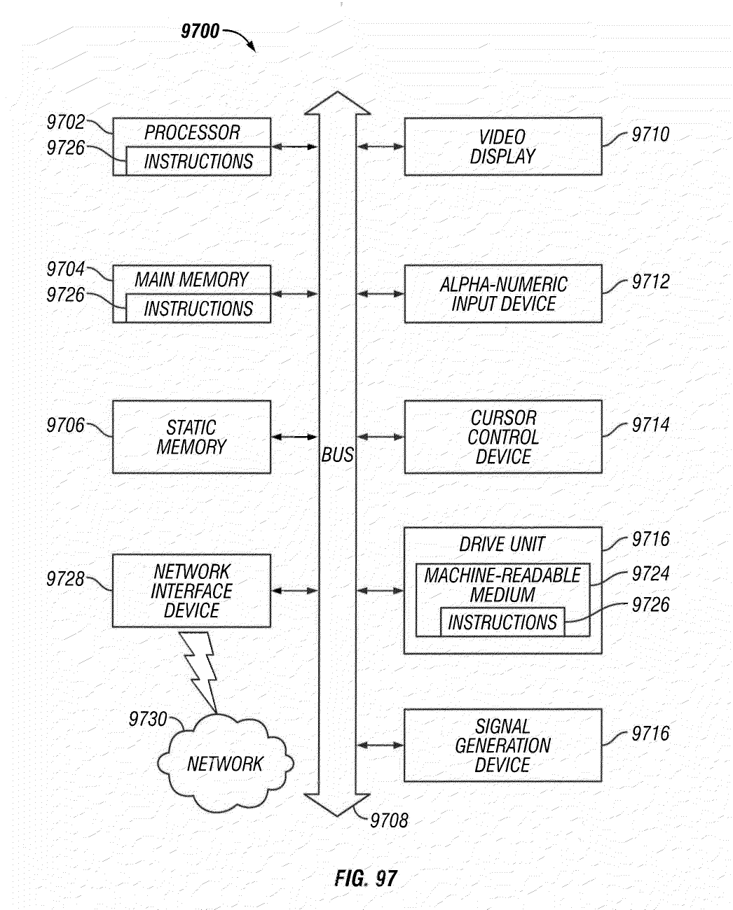

FIG. 97 is a block schematic diagram of a system in the exemplary form of a computer system 9700 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 9700 includes a processor 9702, a main memory 9704 and a static memory 9706, which communicate with each other via a bus 9708. The computer system 9700 may further include a display unit 9710, for example, a liquid crystal display (LCD) or a cathode ray tube (CRT). The computer system 9700 also includes an alphanumeric input device 9712, for example, a keyboard; a cursor control device 9714, for example, a mouse; a disk drive unit 9716, a signal generation device 9718, for example, a speaker, and a network interface device 9728.

The disk drive unit 9716 includes a machine-readable medium 9724 on which is stored a set of executable instructions, i.e. software, 9726 embodying any one, or all, of the methodologies described herein below. The software 9726 is also shown to reside, completely or at least partially, within the main memory 9704 and/or within the processor 9702. The software 9726 may further be transmitted or received over a network 9730 by means of a network interface device 9728.

In contrast to the system 9700 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations, e.g. requiring cables and complex software configurations, e.g. requiring a consultant to install. For example, embodiments may provide one or more cloud computing solutions that enable users, e.g. users on the go, to use the mathematical tools on such internet-enabled or other network-enabled devices, servers, or clients. It further should be appreciated that one or more cloud computing embodiments include mathematical tools using mobile devices, tablets, and the like, as such devices are becoming standard consumer devices.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for providing a mathematical instructional tool, comprising:
one or more processors;
a storage in communication with said one or more processors; and
a display in communication with said one or more processors and with said storage, said display configured for displaying a graphical user interface (GUI) as part of the mathematical instructional tool, said GUI comprising:
a context field configured to receive and to display text, numbers, or symbols that describe a mathematical problem;
a paraphrase section configured to display a type of paraphrase of one or more predetermined paraphrases and wherein a paraphrase contains fields, wherein the paraphrase paraphrases the mathematical problem from the context section into a combination of text, numbers, or symbols in one or more of the paraphrase fields, and wherein the paraphrase fields directly correspond to values of the mathematical problem;
a model section configured to display a type of model of one or more predetermined models and wherein a model shows a visual representation of any of the values of the mathematical problem; and
an equation section configured to display parts of or all of an equation that represents the values of the mathematical problem and solution;
wherein a processor of said one or more processors is a checking processor that checks whether:
values in the paraphrase section, model section, and equation correspond correctly to each other and when said values do not correctly correspond then use the differences to provide strategic feedback; and
the values in the equation are correct.

2. The apparatus of claim 1, wherein each of said context field, paraphrase section, model section, and equation section is configured to be selected as hidden or shown, wherein selected as hidden means not displayed on the display and wherein selected as shown means displayed on the display.

3. The apparatus of claim 1, wherein any two of said paraphrase section, model section, and equation section are selected as linked, wherein:
when the paraphrase section and model section are linked, then the model section is automatically updated when the paraphrase section is changed and the paraphrase section is automatically updated when the model section is changed;
when the paraphrase section and equation section are linked, then the equation section is automatically updated when the paraphrase section is changed and the paraphrase section is automatically updated when the equation section is changed; and
when the model section and the equation section are linked, then the equation section is automatically updated when the model section is changed and the model section is automatically updated when the equation section is changed.

4. The apparatus of claim 1, wherein the context field and any other fields within each of the paraphrase section, model section, and equation section are allowed to be locked, wherein when a field is locked, information presented in the field cannot be directly edited by a user.

5. The apparatus of claim 1, wherein:
when the context field is unlocked, the context field is editable by a user entering or deleting text in the context field;
when the context field is locked, the text of the context field is not directly editable by a user but a particular word, phrase, number, or symbol is selectable and subsequently movable to an editable field in the paraphrase section or the equation section via copy-and-paste or drag-and-drop operations;
an author can specify words to be grouped into a phrase when selected and dragged by a user;
any of the fields of the paraphrase section can be typed into directly;
the fields of the paraphrase section correlate to fields in the model section and to fields in the equation section and fields in the model section correlate to fields in the equation section; and
accuracy of the paraphrase is checkable by the checking processor.

6. The apparatus of claim 1, wherein the one or more predetermined paraphrases comprise a groups of paraphrase and a part of paraphrase, wherein a groups of paraphrase depicts a groups of problem with a multiplier greater than or equal to one and wherein a part of paraphrase depicts a part of problem with a multiplier less than one.

7. The apparatus of claim 1, wherein:
the one or more predetermined models comprise a two number line model using two parallel number lines and a two area model using two adjacent models;
when the mathematical problem is a groups of problem for multiplying, the two number line model uses two parallel number lines to depict a multiplicand, effect of a multiplier, and a product of the mathematical problem;
when the mathematical problem is a groups of problem for multiplying, the two area model uses two adjacent models to depict a multiplicand, effect of a multiplier, and a product of the mathematical problem;
an author can specify that a subset of models are available to a user;
an author can specify the model that is initially shown to a user; and
when more than one model is available, a model can be chosen by a user wherein the chosen model displays the same mathematical values as the prior model and the values in other sections are not affected when the model is changed.

8. The apparatus of claim 1, wherein the equation section comprises five portions: multiplier, multiplicand, product, restated product, and unit, and wherein:
the restated product can be hidden or shown;
the multiplicand and multiplier can be independently linked from the equation to the model wherein changes in the equation are propagated to the corresponding values in the model except that unlinked values in the model are not changed;
the multiplicand, multiplier, and product can be independently linked from the model to the equation wherein changes in the model are propagated to the corresponding values in the equation except that unlinked values in the equation are not changed;
the multiplicand and multiplier can be linked from the equation to the corresponding values in the paraphrase through linkages from the equation to the model and from the model to the paraphrase;
the multiplicand and multiplier can be linked from the paraphrase to the corresponding values in the equation though linkages from the paraphrase to the model and from the model to the equation;
the units field can be linked from the equation to the paraphrase wherein changes to the equation's unit field are propagated to the paraphrase's unit field;
the units field can be linked from the paraphrase to the equation wherein changes to the paraphrase's unit field are propagated to the equation's unit field;
any of the numerators, denominators, whole numbers, or units fields can be pre-populated by an author;
any of the numerators, denominators, whole numbers, or units fields can be locked by an author and causing the fields to be un-editable directly by a user except that the values are changeable through linking;
levels of checking by the checking processor are modifiable by authors as part of creating a lesson;
the unit is checkable by the checking processor; and
the unit field is populated in the equation section by text being dragged from the context or paraphrase or by the unit field being typed into directly.

9. The apparatus of claim 1, wherein the mathematical instructional tool is configured by an author for constructing a lesson, wherein:
the author enters variables for each of the context field, the paraphrase section, the model section, and the equation section;
the author configures one or more variables for each of the context field, the paraphrase section, the model section, and the equation section; wherein the one or more variables indicate:
which of the context field, the paraphrase section, the model section and which are hidden;
the text and numbers entered into the context field;
words, phrases, and numbers that can be selected as the multiplicand, the multiplier, and the unit;
indicators for which words, phrases, and numbers are correct choices as a multiplicand, a multiplier, and unit;
the set of paraphrases that are available to a user;
the type of paraphrase to be initially displayed on the display;
the paraphrase that is correct;
the set of models that are available to a user;
the type of model to be initially used;
whether the model section is linked to the paraphrase section;
whether the model section is linked to the equation section;
parts of the model that are pre-populated;
parts of the model that are locked;
how much of an equation is displayed on the display, comprising: nothing, the simplified product only with the units, the simplified product only, the product before it is simplified, the starting value, and the multiplier;
parts of the equation which are:
pre-populated or empty; and
locked or unlocked;
whether mixed number are enabled; and
custom feedback that users receive upon making errors.

10. A computer-implemented method for providing a mathematical instructional tool, comprising:
providing one or more processors;
providing a storage in communication with said one or more processors; and
providing a display in communication with said one or more processors and with said storage, said display configured for displaying a graphical user interface (GUI) as part of the mathematical instructional tool, said GUI comprising:
a context field configured to receive and to display text, numbers, or symbols that describe a mathematical problem;
a paraphrase section configured to display a type of paraphrase of one or more predetermined paraphrases and wherein a paraphrase contains fields, wherein the paraphrase paraphrases the mathematical problem from the context section into a combination of text, numbers, or symbols in one or more of the paraphrase fields, and wherein the paraphrase fields directly correspond to values of the mathematical problem;
a model section configured to display a type of model of one or more predetermined models and wherein a model shows a visual representation of any of the values of the mathematical problem; and
an equation section configured to display parts of or all of an equation that represents the values of the mathematical problem and solution;
wherein a processor of said one or more processors is a checking processor that checks whether:
values in the paraphrase section, model section, and equation correspond correctly to each other and when said values do not correctly correspond then use the differences to provide strategic feedback; and
the values in the equation are correct.

11. The method of claim 10, wherein each of said context field, paraphrase section, model section, and equation section is configured to be selected as hidden or shown, wherein selected as hidden means not displayed on the display and wherein selected as shown means displayed on the display.

12. The method of claim 10, wherein any two of said paraphrase section, model section, and equation section are selected as linked, wherein:
when the paraphrase section and model section are linked, then the model section is automatically updated when the paraphrase section is changed and the paraphrase section is automatically updated when the model section is changed;
when the paraphrase section and equation section are linked, then the equation section is automatically updated when the paraphrase section is changed and the paraphrase section is automatically updated when the equation section is changed; and
when the model section and the equation section are linked, then the equation section is automatically updated when the model section is changed and the model section is automatically updated when the equation section is changed.

13. The method of claim 10, wherein the context field and any other fields within each of the paraphrase section, model section, and equation section are allowed to be locked, wherein when a field is locked, information presented in the field cannot be directly edited by a user.

14. The method of claim 10, wherein:
when the context field is unlocked, the context field is editable by a user entering or deleting text in the context field;
when the context field is locked, the text of the context field is not directly editable by a user but a particular word, phrase, number, or symbol is selectable and subsequently movable to an editable field in the paraphrase section or the equation section via copy-and-paste or drag-and-drop operations;
an author can specify words to be grouped into a phrase when selected and dragged by a user;
any of the fields of the paraphrase section can be typed into directly;
the fields of the paraphrase section correlate to fields in the model section and to fields in the equation section and fields in the model section correlate to fields in the equation section; and
accuracy of the paraphrase is checkable by the checking processor.

15. The method of claim 10, wherein the one or more predetermined paraphrases comprise a groups of paraphrase and a part of paraphrase, wherein a groups of paraphrase depicts a groups of problem with a multiplier greater than or equal to one and wherein a part of paraphrase depicts a part of problem with a multiplier less than one.

16. The method of claim 10, wherein:
the one or more predetermined models comprise a two number line model using two parallel number lines and a two area model using two adjacent models;
when the mathematical problem is a groups of problem for multiplying, the two number line model uses two parallel number lines to depict a multiplicand, effect of a multiplier, and a product of the mathematical problem;
when the mathematical problem is a groups of problem for multiplying, the two area model uses two adjacent models to depict a multiplicand, effect of a multiplier, and a product of the mathematical problem;
an author can specify that a subset of models are available to a user;
an author can specify the model that is initially shown to a user; and
when more than one model is available, a model can be chosen by a user wherein the chosen model displays the same mathematical values as the prior model and the values in other sections are not affected when the model is changed.

17. The method of claim 10, wherein the equation section comprises five portions: multiplier, multiplicand, product, restated product, and unit, and wherein:
the restated product can be hidden or shown;
the multiplicand and multiplier can be independently linked from the equation to the model wherein changes in the equation are propagated to the corresponding values in the model except that unlinked values in the model are not changed;
the multiplicand, multiplier, and product can be independently linked from the model to the equation wherein changes in the model are propagated to the corresponding values in the equation except that unlinked values in the equation are not changed;
the multiplicand and multiplier can be linked from the equation to the corresponding values in the paraphrase through linkages from the equation to the model and from the model to the paraphrase;
the multiplicand and multiplier can be linked from the paraphrase to the corresponding values in the equation though linkages from the paraphrase to the model and from the model to the equation;
the units field can be linked from the equation to the paraphrase wherein changes to the equation's unit field are propagated to the paraphrase's unit field;
the units field can be linked from the paraphrase to the equation wherein changes to the paraphrase's unit field are propagated to the equation's unit field;
any of the numerators, denominators, whole numbers, or units fields can be pre-populated by an author;
any of the numerators, denominators, whole numbers, or units fields can be locked by an author and causing the fields to be un-editable directly by a user except that the values are changeable through linking;
levels of checking by the checking processor are modifiable by authors as part of creating a lesson;
the unit is checkable by the checking processor; and
the unit field is populated in the equation section by text being dragged from the context or paraphrase or by the unit field being typed into directly.

18. The method of claim 10, wherein the mathematical instructional tool is configured by an author for constructing a lesson, wherein:
the author enters variables for each of the context field, the paraphrase section, the model section, and the equation section;
the author configures one or more variables for each of the context field, the paraphrase section, the model section, and the equation section; wherein the one or more variables indicate:
which of the context field, the paraphrase section, the model section and which are hidden;
the text and numbers entered into the context field;
words, phrases, and numbers that can be selected as the multiplicand, the multiplier, and the unit;
indicators for which words, phrases, and numbers are correct choices as a multiplicand, a multiplier, and unit;
the set of paraphrases that are available to a user;
the type of paraphrase to be initially displayed on the display;
the paraphrase that is correct;
the set of models that are available to a user;
the type of model to be initially used;
whether the model section is linked to the paraphrase section;
whether the model section is linked to the equation section;
parts of the model that are pre-populated;
parts of the model that are locked;
how much of an equation is displayed on the display, comprising: nothing, the simplified product only with the units, the simplified product only, the product before it is simplified, the starting value, and the multiplier;
parts of the equation which are:
pre-populated or empty; and
locked or unlocked;
whether mixed number are enabled; and
custom feedback that users receive upon making errors.
